(19) United States
(12) Patent Application Publication
(10) Pub. No.: US 2024/0341006 A1
(43) Pub. Date: Oct. 10, 2024

(54) METHOD AND APPARATUS FOR EXTENDED DISCONTINUOUS RECEPTION IN WIRELESS COMMUNICATION SYSTEM

(71) Applicant: Samsung Electronics Co., Ltd., Gyeonggi-do (KR)

(72) Inventors: Seungbeom JEONG, Gyeonggi-do (KR); Sangyeob JUNG, Gyeonggi-do (KR)

(21) Appl. No.: 18/626,757

(22) Filed: Apr. 4, 2024

(30) Foreign Application Priority Data
Apr. 5, 2023 (KR) 10-2023-0044864

(51) Int. Cl. H04W 76/28; H04W 68/00; H04W 76/27

(52) U.S. Cl. CPC H04W 76/28; H04W 68/005; H04W 76/27

(57) ABSTRACT

The disclosure relates to fifth generation (5G) or sixth generation (6G) communication systems to support higher data rates. Specifically, the disclosure provides a method for extended discontinuous reception (eDRX). In accordance with an aspect of the disclosure, a method performed by a user equipment (UE) in a wireless communication system includes: identifying, for a radio resource control (RRC) inactive state, a first extended discontinuous reception (eDRX) cycle associated with a core network (CN) entity and a second eDRX cycle associated with a radio access network (RAN) node; and monitoring a paging occasion in the RRC inactive state according to a DRX cycle, wherein, in case that the first eDRX cycle is longer than 1024 radio frames and the second eDRX cycle is longer than 1024 radio frames: during an overlapped period of a first paging time window associated with the CN entity and a second paging time window associated with the RAN node, the DRX cycle is determined by a shortest value among a first UE specific value configured by an upper layer, a second UE specific value configured by an RRC, and a default DRX value broadcasted in system information; during a period included in the first paging time window associated with the CN entity and being outside of the second paging time window associated with the RAN node, the DRX cycle is determined by a shortest value among the first UE specific value configured by the upper layer and the default DRX value broadcasted in the system information; and during a period included in the second paging time window associated with the RAN node and being outside of the first paging time window associated with the CN entity, the DRX cycle is determined by the second UE specific value configured by the RRC.

### CROSS-REFERENCE TO RELATED APPLICATION(S)

This application is based on and claims priority under 35 U.S.C. § 119 to Korean Patent Application No. 10-2023-0044864, filed on Apr. 5, 2023, in the Korean Intellectual Property Office, the disclosure of which is incorporated herein by reference in its entirety.

### BACKGROUND

### 1. Field

The disclosure relates generally to the field of communication, and more particularly, to a user equipment (UE), a base station (BS), and methods thereof for extended discontinuous reception (eDRX) in wireless communication systems.

### 2. Description of Related Art

Fifth generation (5G) mobile communication technologies define broad frequency bands such that high transmission rates and new services are possible, and can be implemented not only in sub 6 gigahertz (GHz) bands such as 3.5 GHz, but also in above 6 GHz bands referred to as millimeter wave (mmWave) including 28 GHz and 39 GHz. In addition, it has been considered to implement sixth generation (6G0 mobile communication technologies (referred to as beyond 5G systems) in terahertz (THz) bands, such as 95 GHz to 3 THz bands, to achieve transmission rates fifty times faster than 5G mobile communication technologies and ultra-low latencies one-tenth of 5G mobile communication technologies.

Since the outset of the development of 5G mobile communication technologies, to support services and to satisfy performance requirements in connection with enhanced mobile broadband (eMBB), ultra reliable low latency communications (URLLC), and massive machine-type communications (mMTC), there has been ongoing standardization regarding beamforming and massive multiple input multiple output (MIMO) for mitigating radio-wave path loss and increasing radio-wave transmission distances in mmWave, operating multiple subcarrier spacings for efficiently utilizing mmWave resources and dynamic operation of slot formats, initial access technologies for supporting multi-beam transmission and broadbands, definition and operation of bandwidth part (BWP), new channel coding methods such as a low density parity check (LDPC) code for large amounts of data transmission and a polar code for highly reliable transmission of control information, layer 2 (L2) pre-processing, and network slicing for providing a dedicated network specialized to a specific service.

Discussions ensue regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR UE power saving, non-terrestrial network (NTN) which is UE-satellite direct communication for providing coverage in an area in which communication with terrestrial networks is unavailable, and positioning.

There is also ongoing standardization in air interface architecture/protocol regarding technologies such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step RACH for NR). There is also ongoing standardization in system architecture/service regarding a 5G baseline architecture (e.g., service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Such development of 5G mobile communication systems will serve as a basis for developing not only new waveforms for providing coverage in terahertz bands of 6G mobile communication technologies, multi-antenna transmission technologies such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

A wireless communication system is advancing to a broadband wireless communication system for providing high-speed and high-quality packet data services using communication standards, such as high-speed packet access (HSPA) of 3GPP, LTE (long-term evolution) or evolved universal terrestrial radio access (E-UTRA), LTE-advanced (LTE-A), LTE-Pro, high-rate packet data (HRPD) of 3GPP2, ultra-mobile broadband (UMB), institute of electrical and electronics engineers (IEEE) 802.16e, and typical voice-based services.

An LTE system employs an orthogonal frequency division multiplexing (OFDM) scheme in a downlink (DL) and employs a single carrier frequency division multiple access (SC-FDMA) scheme in an uplink (UL), which indicates a radio link through which a UE (or a mobile station (MS)) transmits data or control signals to a BS (BS or eNode B), and the DL indicates a radio link through which the BS transmits data or control signals to the UE. The above multiple access scheme separates data or control information of respective users by allocating and operating time-frequency resources for transmitting the data or control information for each user so as to avoid overlapping each other, that is, to establish orthogonality.

Since a 5G communication system, which is a communication system subsequent to LTE, must freely reflect various requirements of users and service providers, services satisfying various requirements including eMBB, mMTC, and URLLC, need to be supported.

### SUMMARY

The disclosure has been made to address at least the above-mentioned problems and/or disadvantages and to provide at least the advantages described below.

Accordingly, an aspect of the disclosure is to provide an apparatus and method capable of effectively providing services in a mobile communication system.

In accordance with an aspect of the disclosure, a method performed by a user equipment (UE) in a wireless communication system includes: identifying, for a radio resource control (RRC) inactive state, a first extended discontinuous reception (eDRX) cycle associated with a core network (CN) entity and a second eDRX cycle associated with a radio access network (RAN) node; and monitoring a paging occasion in the RRC inactive state according to a DRX cycle, wherein, in case that the first eDRX cycle is longer than 1024 radio frames and the second eDRX cycle is longer than 1024 radio frames: during an overlapped period of a first paging time window associated with the CN entity and a second paging time window associated with the RAN node, the DRX cycle is determined by a shortest value among a first UE specific value configured by an upper layer, a second UE specific value configured by an RRC, and a default DRX value broadcasted in system information; during a period included in the first paging time window associated with the CN entity and being outside of the second paging time window associated with the RAN node, the DRX cycle is determined by a shortest value among the first UE specific value configured by the upper layer and the default DRX value broadcasted in the system information; and during a period included in the second paging time window associated with the RAN node and being outside of the first paging time window associated with the CN entity, the DRX cycle is determined by the second UE specific value configured by the RRC.

The disclosed embodiment is able to effectively provide services in a mobile communication system.

### BRIEF DESCRIPTION OF THE DRAWINGS

The foregoing and other aspects, features and advantages of certain embodiments of the present disclosure will become more apparent from the following description with reference to the accompanying drawings, in which:

FIG. 1 illustrates a next-generation mobile communication system according to an embodiment;

FIG. 2 illustrates switching of a wireless connection state in a next-generation mobile communication system according to an embodiment;

FIG. 3 illustrates an operation in which a BS (or network) broadcasts a paging occasion (PO) and a paging message according to an embodiment;

FIG. 4 illustrates a core network (CN) paging reception procedure of UE in a idle mode according to an embodiment;

FIG. 5 illustrates a random access network (RAN) paging reception procedure of UE in an inactive mode according to an embodiment;

FIG. 6 illustrates a procedure for UE to determine a paging monitoring cycle according to an embodiment;

FIG. 7 illustrates a paging procedure using eDRX in LTE according to an embodiment;

FIG. 8 illustrates a UE device according to an embodiment; and

FIG. 9 illustrates a BS device according to an embodiment.

### DETAILED DESCRIPTION

The following description with reference to the accompanying drawings is provided to assist in a comprehensive understanding of embodiments of the present disclosure. Accordingly, those of ordinary skill in the art will recognize that various changes and modifications of the embodiments described herein can be made without departing from the scope and spirit of the present disclosure. Descriptions of well-known functions and constructions may be omitted for the sake of clarity and conciseness.

Similarly, in the accompanying drawings, some elements may be exaggerated, omitted, or schematically illustrated and the size of each element does not completely reflect the actual size. The same or corresponding elements are provided with the same or corresponding reference numerals.

The following embodiments are provided only to completely explain the disclosure and inform those skilled in the art of the scope of the disclosure. Herein, the same or like reference signs indicate the same or like elements.

As used herein, a unit refers to a software element or a hardware element, such as a field programmable gate array (FPGA) or an application specific integrated circuit (ASIC), which performs a predetermined function. However, the unit does not always apply to software or hardware and may be constructed either to be stored in an addressable storage medium or to execute one or more processors. Therefore, the unit includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the unit may be either combined into fewer elements, or a unit, or divided more elements, or a unit. The elements and units or may be implemented to reproduce one or more central processing units (CPUs) within a device or a security multimedia card.

In the following description, terms for identifying access nodes and for referring to network entities, messages, interfaces between network entities, various identification information, and the like are illustratively used for the sake of convenience. Therefore, the disclosure is not limited by the terms as used below, and other terms referring to subjects having equivalent technical meanings may be used.

Terms and names defined in the 3rd generation partnership project long term evolution (3GPP LTE) standards will be used for the sake of descriptive convenience. However, the disclosure is not limited by these terms and names, and may be similarly applied to systems that conform other standards. As to a BS, the term eNB may be interchangeably used with the term gNB for the sake of descriptive convenience. The term terminal may refer to mobile phones, node B (NB)-IoT devices, sensors, and various wireless communication devices.

Herein, a BS allocates resources to terminals, and may be at least one of a gNode B, an eNode B, an NB, a wireless access unit, a BS controller, and a node on a network. A terminal may include a user equipment (UE), a mobile station (MS), a cellular phone, a smartphone, a computer, or a multimedia system capable of performing communication functions. The BS and the terminal are not limited to these examples.

The disclosure may be applied to 3GPP NR and to intelligent services (e.g., smart homes, smart buildings, smart cities, smart cars or connected cars, healthcare, digital education, retail business, security and safety-related services, etc.) based on 5G communication and IoT-related technology.

Herein, LTE, LTE-A, LTE Pro, or 5G (or NR, next-generation mobile communication) systems will be described by way of example, but the disclosure may also be applied to other communication systems having similar technical backgrounds or channel types to the embodiments of the disclosure. Based on determinations by those skilled in the art, the embodiments of the disclosure may also be applied to other communication systems through some modifications without significantly departing from the scope of the disclosure.

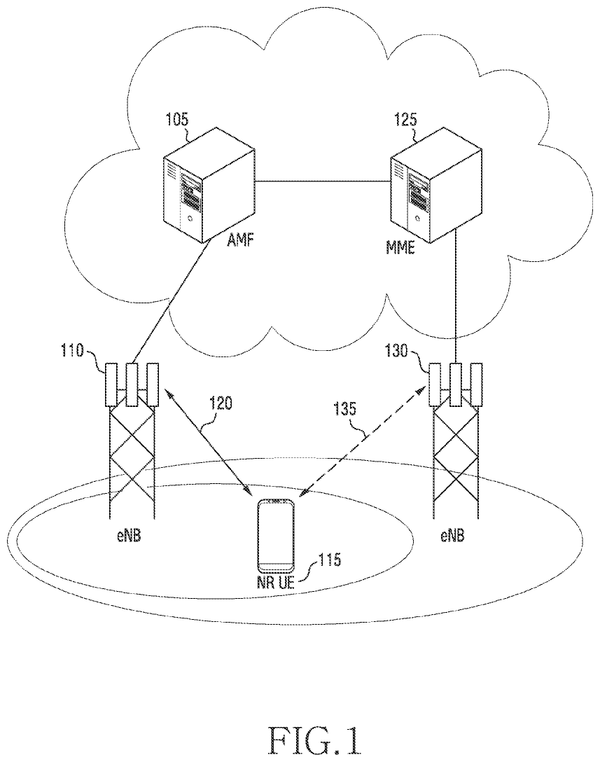

FIG. 1 illustrates a next-generation mobile communication system according to an embodiment.

Referring to FIG. 1, a radio access network of a wireless communication system (hereinafter next-generation mobile communication system, NR, or 5G) may include a next-generation BS (gNB: NR node b) 110 and an NR core network. The NR CN may include, but limited thereto, an access management function (AMF) 105. A user terminal (NR UE: new radio user equipment) 115 may access an external network via the gNB 110 and the AMF 105.

In FIG. 1, the gNB 110 may correspond to an evolved node B (eNB) of a conventional LTE system. The gNB 110 may be connected to the NR UE 115 through a radio channel 120 and may provide improved services as compared to a conventional node B. In the next-generation mobile communication system, since all user traffic is serviced through a shared channel, the gNB 110 may serve as a device that collects state information, such as buffer statuses, available transmit power states, and channel states of UEs, and performs scheduling, as required. One gNB 110 may control multiple cells. To implement ultrahigh-speed data transfer beyond the current LTE, the next-generation mobile communication system may provide a wider bandwidth than the existing maximum bandwidth, may employ an orthogonal frequency division multiplexing (OFDM) as a radio access technology, and may additionally use a beamforming technology.

The NR gNB 110 may employ an adaptive modulation & coding (AMC) scheme for determining a modulation scheme and a channel coding rate according to a channel state of a UE. The AMF 105 may perform functions such as mobility support, bearer configuration, and QoS configuration, is responsible for various control functions as well as a mobility management function for a UE, and may be connected to multiple BSs. In addition, the next-generation mobile communication system may interwork with the existing LTE system, and the AMF 105 may be connected to a mobility management entity (MME) 125 via a network interface. The MME 125 may be connected to an eNB 130 that is an existing BS. A UE supporting LTE-NR dual connectivity may transmit/receive data while maintaining connections to both the gNB 110 and the eNB 130.

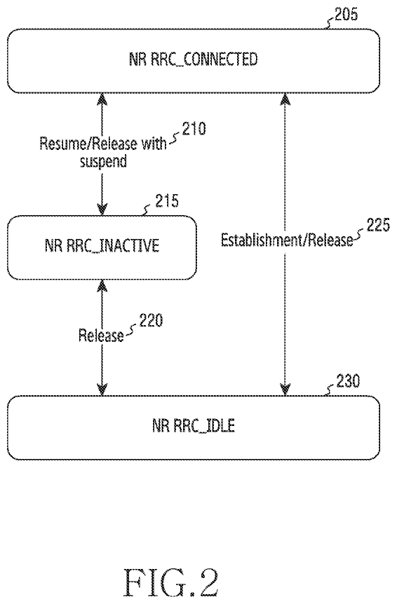

FIG. 2 illustrates switching of a wireless connection state in a next-generation mobile communication system according to an embodiment.

Herein, a UE may have three radio resource control (RRC) wireless connection states in a next-generation mobile communication system. A connection mode (RRC_CONNECTED) 205 may indicate that the UE is in a wireless connection state capable of transmitting and receiving data. A idle mode (RRC_IDLE) 230 may indicate that the UE is in a wireless connection state of monitoring whether paging is transmitted to the UE. The connection mode 205 and the idle mode 230 are wireless connection states that may also be applied to the LTE system, and the details thereof may be the same as those of the LTE system. An inactive mode (RRC_INACTIVE) 215 may be newly applied, as well as the connection mode 205 and the idle mode 230, to the next-generation mobile communication system. The RRC_INACTIVE 215 state may correspond to an inactive wireless connection state, an inactive mode, a deactivated mode, or the like.

In the inactive mode 215 wireless connection state, the UE context may be maintained in the BS and the UE, and radio access network (RAN)-based paging may be supported. The characteristics of the inactive mode 215 wireless connection state are as follows.
Cell re-selection mobility,
CN-NR RAN connection (both C/U-planes) has been established for UE,
UE AS context is stored in at least one gNB and the UE,
Paging is initiated by NR RAN (i.e., RAN paging),
RAN-based notification area is managed by NR RAN, and
NR RAN knows the RAN-based notification area to which the UE belongs.

The UE in the inactive mode 215 may switch to the connection mode 205 or the idle mode 230 through a specific procedure.

In step 210, the UE may switch from the inactive mode 215 to the connection mode 205 according to a resume process, and switch from the connection mode 205 to the inactive mode 215 through a release procedure including suspend setting information. One or more RRC messages may be transmitted and received between the UE and the BS in step 210, and step 210 may include one or more detailed steps.

In step 220, the UE may switch from the inactive mode 215 to the idle mode 230 through the release procedure 220 after the resume procedure.

In step 225, switching between the connection mode 205 and the idle mode 230 may be performed according to conventional LTE technology, such as an establishment or release procedure.

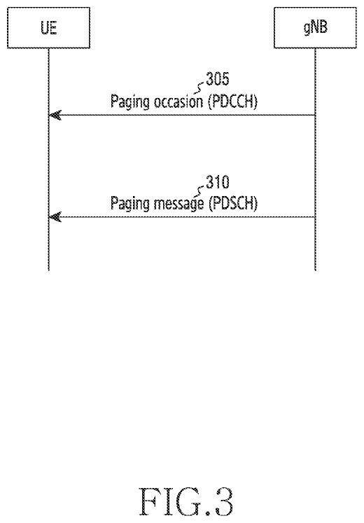

FIG. 3 illustrates an operation in which a BS (or network) broadcasts a PO and a paging message according to an embodiment.

A 5G or next-generation radio access network (NG-RAN) based on NR may include NG-RAN nodes, and the NG-RAN node may correspond to a gNB. The gNB may provide NR user plane (UP) and control plane (CP) protocol termination to the UE. In addition, gNBs are connected through an NG interface for the 5G core (5GC), and more specifically, are connected to an AMF by an NG-control (NG-C) interface and to a UP function (UPF) by an NG-user (NG-U) interface.

Additionally, in a 5G, e.g., NR, wireless communication system, the UE may use DRX to reduce power consumption in the RRC_IDLE or RRC_INACTIVE mode. In an RRC_IDLE or RRC_INACTIVE state, the UE may monitor the physical downlink control channel (PDCCH) periodically (e.g., in every DRX cycle) only for a short period of time, instead of consistently monitor the PDCCH, to receive a PO, a system information (SI) update notification, or an emergency notification.

Referring to FIG. 3, the paging message 310 may be transmitted through a physical downlink shared channel (PDSCH). If there is a paging message 310 in the PDSCH, the PDCCH may be displayed as a paging radio network temporary identifier (P-RNTI). The P-RNTI may be common for all UEs. A UE identity, such as the system architecture evolution (SAE) temporary mobile subscription identifier (S-TMSI) for the UE in the RRC_IDLE state or the inactive radio network temporary identifier (I-RNTI) for the UE in the RRC_INACTIVE state, may be included in the paging message 310 to indicate paging for a specific UE.

The paging message 310 may include multiple UE identities for paging multiple UEs. The paging message 310 may be broadcast over a data channel (e.g., PDSCH) (for example, the PDCCH is masked with the P-RNTI). SI updates and emergency notifications are included in downlink control information (DCI), and the PDCCH carrying the DCI may be indicated as a P-RNTI. In the RRC_IDLE or RRC_INACTIVE mode, the UE may monitor one PO 305 every DRX cycle. In the RRC_IDLE or RRC_INACTIVE mode, the UE may monitor the PO in the initial DL bandwidth part (DL BWP). In the RRC connected state, the UE may monitor one or more POs to receive SI update notifications and emergency notifications. The UE may monitor all POs in the paging DRX cycle and monitor at least one PO in the SI modification period. In the RRC_IDLE or RRC_INACTIVE mode, the UE may monitor the PO in the active DL BWP. The PO is a set of S PDCCH monitoring occasions for paging, where S may indicate the number of synchronization signal and physical broadcast channel (PBCH) blocks (SSBs) transmitted in the cell. The UE may first determine a paging frame (PF) and then determine a PO for the determined PF. One PF may be a radio frame of 10 ms. The PF and PO may be determined as follows, but the disclosure is not limited thereto.
The PF for a UE is the radio frame with system frame number (SFN) which satisfies the expression (SFN+PF_offset) mod T=(T div N)*(UE_ID mod N).

Index (i_s), indicating the index of the PO, is determined by i_s=floor (UE_ID/N) mod Ns.

T is the DRX cycle of the UE.

In the RRC_INACTIVE state, T is determined by the shortest of the UE specific DRX value configured by RRC, UE specific DRX value configured by a non-access stratum (NAS), and a default DRX value broadcast in SI.

In the RRC_IDLE state, T is determined by the shortest of UE specific DRX value configured by NAS and a default DRX value broadcast in SI. If the UE specific DRX is not configured by upper layers (i.e., NAS), the default value is applied.
N is the number of total paging frames in T
Ns is the number of POs for a PF
PF_offset is the offset used for PF determination
UE_ID is 5G-S-TMSI mod 1024

Parameters Ns, nAndPagingFrameOffset, and the length of default DRX Cycle are signaled in SIB1. The values of N and PF_offset are derived from the parameter nAndPagingFrameOffset as defined in TS 38.331. If the UE has no 5G-S-TMSI, for instance when the UE has not yet registered onto the network, the UE shall use as default identity UE_ID=0 in the PF and i_s formulas above.

The PDCCH monitoring occasions for paging are determined based on paging search space configuration (paging-SearchSpace) signaled by the gNB.

If SearchSpaceId=0 is configured for pagingSearchSpace, the PDCCH monitoring timing for paging is the same as for remaining SI (RMSI) (see the definition in clause 13 in TS 38.213). If SearchSpaceId=0 is configured for pagingSearchSpace, Ns may be 1 or 2. If Ns=1, there is only a single PO starting from the first PDCCH monitoring time for paging in the PF. If Ns=2, the PO exists in the first half frame (i_s=0) or the second half frame (i_s=1) of the PF.

If a non-zero SearchSpaceId is configured for pagingSearchSpace, the UE may monitor the (i_s+1)^{th} PO. The PDCCH monitoring time for paging is determined based on the paging search space configuration (paging-SearchSpace) signaled by the gNB. In the case of PDCCH monitoring for paging that does not overlap the UL symbol (determined according to tdd-UL-DL-ConfigurationCommon), the numbering may be sequential from 0, i.e., from the first PDCCH monitoring time for paging in the PF. The gNB may signal the parameter firstPDCCH-MonitoringOccasionOfPO for each PO corresponding to the PF. If firstPDCCH-MonitoringOccasionOfPO is signaled, the (i_s+1)^{th} PO is a set of S consecutive PDCCH monitoring times for paging, starting from the PDCCH monitoring time number indicated by firstPDCCH-MonitoringOccasionOfPO. That is, the (i_s+1)^{th} value of firstPDCCH-MonitoringOccasionOfPO parameter or the (i_s+1)^{th} PO may be a set of S consecutive PDCCH monitoring times for paging, starting from the (i_s*S)^{th} PDCCH monitoring time for paging. S may be the number of actually transmitted SSBs determined according to the parameter ssb-PositionsInBurst signaled in SystemInformationBlock1 received from the gNB. The parameter of first-PDCCH-MonitoringOccasionOfPO is signaled in SIB1 for paging in the initial DL BWP. When paging from a DL BWP other than the initial DL BWP, the parameter of first-PDCCH-MonitoringOccasionOfPO is signaled in the corresponding BWP configuration.

The PDCCH indicated as a P-RNTI may transmit information according to DCI format 1_0. The information below may indicate information transmitted in DCI format 1_0 using a cyclic redundancy check (CRC) scrambled with a P-RNTI.

Short messages indicator-2 bits according to Table 1 below.

Short messages-8 bits according to Table 2 below. If only the scheduling information for paging is carried, this bit field is reserved.
Frequency domain resource assignment—┌log₂(N_{RB}^{DL,BWP}(N_{RB}^{DL,BWP}+1)/2)┐ bits. If only the short message is carried, this bit field is reserved.
   N_{RB}^{DL,BWP} is the size of CORESET 0

Time domain resource assignment—4 bits as defined in the technical specification (TS) 38.214 standard. If only the short message is carried, this bit field is reserved.

VRB-to-PRB mapping—1 bit according to the TS 38.212 standard. If only the short message is carried, this bit field is reserved.

Modulation and coding scheme—5 bits as defined in the TS 38.214 standard, using Table 5.1.3.1-1. If only the short message is carried, this bit field is reserved.

Transport block (TB) scaling—2 bits as defined in the TS 38.214 standard. If only the short message is carried, this bit field is reserved.

Reserved bits—6 bits

Table 1 below may indicate the short message indicators.

TABLE 1

| Bit field | Short message indicator |
|---|---|
| 00 | Reserved |
| 01 | Only scheduling information for |
| | paging is in the DCI |
| 10 | Only short message is in the DCI |
| 11 | Both scheduling information for |
| | paging and short messages are in the DCI |

Table 2 below defines short messages. Bit 1 may be the most significant bit (MSB).

TABLE 2

| Bit | Short message |
|---|---|
| 1 | systemInfoModification |
| | If set to 1: indication of a BCCH modification |
| | other than SIB6, SIB7 and SIB8. |
| 2 | etwsAndCmasIndication |
| | If set to 1: indication of an ETWS primary |
| | notification and/or an ETWS secondary |
| | notification and/or a CMAS notification. |
| 3-8 | Reserved |

The UE may detect PDCCH transmission from the gNB to monitor the PO (305) and identify a short message indicator therethrough, thereby determining whether there is a paging message. If the UE determines that there is a paging message through the short message indicator, it may receive a PDSCH (e.g., paging message) (310).

The paging message format is as shown in Table 3 below.

TABLE 3

| | |
|---|---|
| Paging ::= | SEQUENCE { |
| pagingRecordList | PagingRecordList |

OPTIONAL, -- Need N

| | |
|---|---|
| lateNonCriticalExtension | OCTET STRING |

OPTIONAL,

| | |
|---|---|
| nonCriticalExtension | SEQUENCE{ } |

OPTIONAL
}

| | |
|---|---|
| PagingRecordList ::= | SEQUENCE (SIZE(1.maxNrofPageRec)) |

OF PagingRecord

| | |
|---|---|
| PagingRecord ::= | SEQUENCE { |
| ue-Identity | PagingUE-Identity, |
| accessType | ENUMERATED {non3GPP} |

OPTIONAL, -- Need N
..
}

| | |
|---|---|
| PagingUE-Identity ::= | CHOICE { |
| ng-5G-S-TMSI | NG-5G-S-TMSI, |
| fullI-RNTI | I-RNTI-Value, |

..
}

One paging message includes a list with a PagingRecord as an entry, and each entry may include ue-Identity to indicate the UE subject to paging. If the UE finds a PagingRecord that is identical to its own UE identity (e.g., S-TMSI or I-RNTI) from the list, the UE may start an operation of switching to the RRC connection mode.

Paging may be classified into two types depending on which entity initiates paging. CN-initiated paging or CN paging indicates that the CN or the AMF or MME initiates paging, and RAN-initiated paging or RAN paging indicates that the RAN (BS, gNB, or eNB) initiates paging.

The UE in the idle mode may monitor a paging channel to receive CN paging. The UE in the inactive mode monitors the paging channel to receive RAN paging, as well as CN paging. The UEs do not need to continuously monitor the paging channel. The UEs may be required to monitor the paging channel only during the PO once in the DRX cycle defined in TS 38.304. The paging DRX cycle may be configured by the network.
1) For CN paging, the default cycle (or default CN paging cycle or default paging cycle) may be broadcast through SI.
2) For CN paging, a UE specific cycle (or UE specific CN paging cycle) may be configured through NAS signaling.
3) For RAN paging, a UE specific cycle (or UE specific RAN paging cycle or RAN paging cycle) may be configured through RRC signaling.

The UE may use the lowest value among the applicable (i.e., configured) DRX cycles depending on the RRC mode as the paging monitoring cycle. That is, the UE in the idle mode may use the lower value of the default CN paging cycle and the UE-specific CN paging cycle (if configured). The UE in the inactive mode may use the lowest value among the default CN paging cycle, the UE-specific CN paging cycle (if configured), and the RAN paging cycle (if configured).

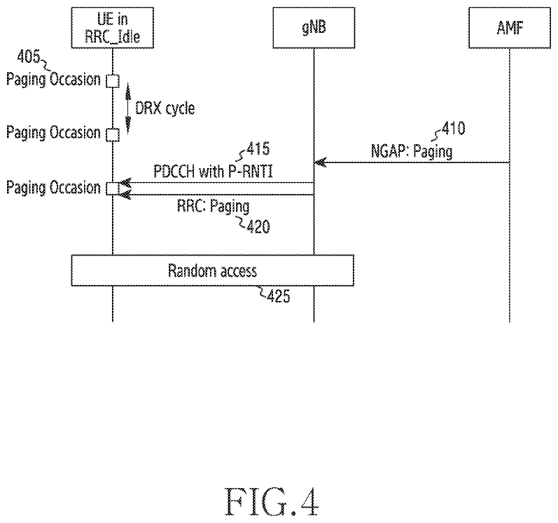

FIG. 4 illustrates a CN paging reception procedure of the UE in a idle mode (RRC_Idle) according to an embodiment.

Referring to FIG. 4, the UE in the idle mode may monitor a paging channel during the PO 405 for every predefined DRX cycle to save energy. That is, the UE may enter a sleep mode between the POs. The UE may scan a PDCCH with CRC scrambled with P-RNTI for each PO. If the UPF receives DL data toward the UE, the UPF may initiate a paging procedure to the AMF through the session management function (SMF). In step 410, the AMF may manage the UE's location information in units of registered tracking areas and broadcast an NG application protocol (NGAP) paging message to all gNBs within the registered tracking areas to which the UE belongs. In step 415, the gNBs having received the NGAP paging message transmit a PDCCH (with a CRC scrambled with P-RNTI) according to the UE's PO. In step 420, the UE scanning the PDCCH may detect transmission of the PDCCH from the gNB and receive an RRC paging message. In step 425, if the UE finds PagingRecord identical to its own UE identity (e.g., S-TMSI or I-RNTI) in the RRC paging message, the UE may perform random access to establish an RRC connection.

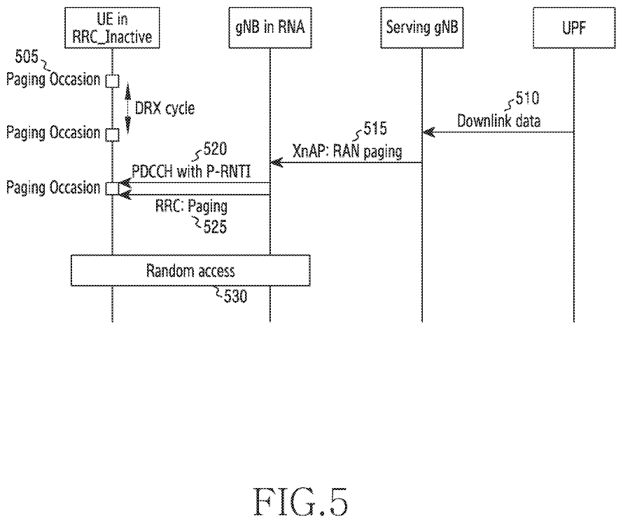

FIG. 5 illustrates a RAN paging reception procedure of the UE in an inactive mode (RRC_Inactive) according to an embodiment.

Referring to FIG. 5, the UE in the inactive mode may monitor a paging channel during the PO 505 for each predefined DRX cycle to save energy. That is, the UE may enter a sleep mode between the POs. The UE may scan the PDCCH with CRC scrambled with P-RNTI for each PO. In step 510, if the UPF receives DL data toward the UE, the UE may transmit the received data to a serving BS (gNB. The serving BS may store or manage the UE's location record in units of RAN notification areas (RNAs). Therefore, in FIG. 515, the serving BS may deliver a Xn application protocol (XnAP) RAN paging message to all gNBs in the RNA to which the UE belongs. In step 520, the gNBs having received the XnAP RAN paging message transmit a PDCCH (with a CRC scrambled with P-RNTI) according to the UE's PO. In step 525, the UE scanning the PDCCH may detect transmission of the PDCCH from the gNB and receive an RRC paging message. In step 530, if the UE finds a PagingRecord identical to its own UE identity (e.g., S-TMSI or I-RNTI) in the RRC paging message, the UE may perform random access to establish an RRC reconnection.

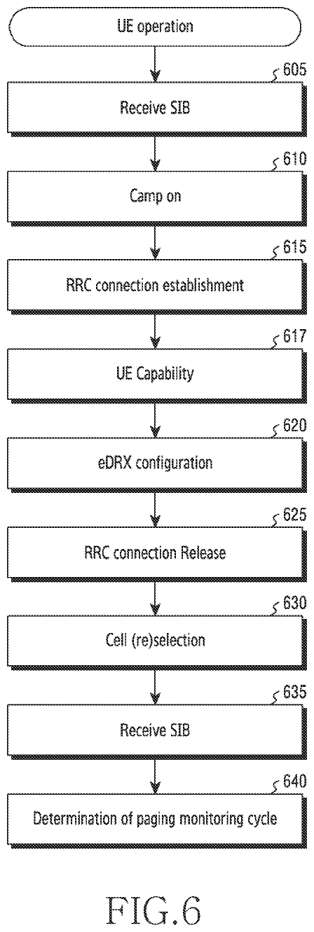

FIG. 6 illustrates a procedure for the UE to determine a paging monitoring cycle according to an embodiment.

Referring to FIG. 6, in step 605, the UE may receive a system information block (SIB). In step 610, the UE may select one cell, based on one or more pieces of received SI, and camp on the selected cell. In step 615, the UE may establish an RRC connection establishment with the camped cell.

In step 617, the UE may report UE capability. For example, the UE may report to the BS whether the UE supports eDRX (e.g., RRC_INACTIVE eDRX).

In step 620, the UE having switched to the RRC connection mode may receive an eDRX configuration (e.g., the eDRX configuration for CN paging or RRC_IDLE mode) from the CN in the negotiation procedure using NAS signaling (e.g., Attach request/accept or a tracking area update request/accept message) with the CN (MME or AMF). The eDRX configuration may include an eDRX cycle (e.g., T_{eDRX} or T_{eDRX_IDLE}). The eDRX configuration may include paging time window (PTW) length information (e.g., the length of PTW or PTW_IDLE).

In step 625, the UE's RRC connection configuration may be released, and the UE may switch the RRC mode to the idle mode (RRC_IDLE) or inactive mode (RRC_INACTIVE). When the BS switches the UE to the inactive mode, the RRC release message may include eDRX configuration information (e.g., eDRX configuration information for RAN paging or RRC_INACTIVE mode). The eDRX setting may include an eDRX cycle (e.g., T_{eDRX_INACTIVE}).

An eDRX configuration may include PTW length information (e.g., the length of PTW_INACTIVE).

In step 630, the UE in the inactive or idle mode may move through several cells and perform cell selection and cell reselection.

In step 635, the UE may receive an SIB of the camped cell or BS. Through this, the UE may receive whether the cell or BS allows or supports eDRX (e.g., eDRX-Allowed, eDRX-AllowedIdle, or eDRX-AllowedInactive).

In step 640, the UE may calculate a paging monitoring cycle in the inactive or idle mode using the received eDRX configuration information, DRX configuration information, SIB indicator, or the like and monitor paging.

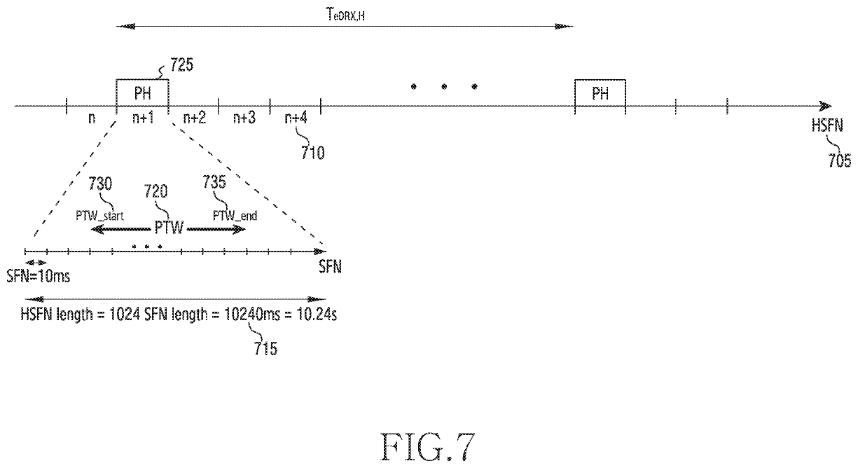

FIG. 7 illustrates a paging procedure using eDRX in LTE according to an embodiment.

If extended DRX (eDRX) is configured to the UE in the idle mode in LTE, the following may be applied. The disclosure is not limited to the below examples.

In the idle mode, the DRX cycle may be extended to 10.24 s or more, and up to 2621.44 s (43.69 minutes).
Hyper slot frame number (Hyper-SFN, H-SFN, or HSFN) 705 is broadcast from the cell, and the HSFN may increase every one cycle of the SFN value. Referring to FIG. 7, if the first HSFN is n, the next HSFN may be n+1, and the next HSFN may be n+2, so that the HSFN increases in such a manner (710). In LTE, as time passes, the SFN value increases by 1 from 0 to 1023 (10 ms per radio frame), and the SFN returns to 0 after reaching 1023, and the HSFN value may increase by 1. As a result, in 715, the length of one HSFN is equal to the length of 1024 SFNs, and may also be equal to 10240 ms (=10.24 s).

Paging hyperframe (PH) may indicate the H-SFN in which the UE starts monitoring paging DRX during the PTW used in the ECM-IDLE mode. The PH may be determined by a formula known to the MME/AMF, UE, and BS, and may be determined as a function of eDRX cycle and UE identity.

During the PTW, the UE may monitor paging 1) during the PTW or 2) until receiving a paging message including the NAS identity of the UE (whichever occurs first). The start offset of the PTW is uniformly distributed within the PH and may be defined according to the 3GPP TS standard.

The MME/AMF may determine the start time of PH and PTW using the formula defined in the 3GPP TS standard. In addition, the MME/AMF may send an S1 paging request just before the start of the PTW or during the PTW to avoid the procedure of storing the paging message in the BS.

When the UE uses eDRX, the requirements of the earthquake and tsunami warning system (ETWS), commercial mobile alert service (CMAS), and public warning system (PWS) may not be satisfied. For extended access barring (EAB), if the UE using eDRX supports SIB14, SIB14 may be acquired before RRC connection establishment.

When the eDRX cycle is longer than the SI modification period, the UE may check whether the stored SI is valid before RRC connection establishment. For the UE configured with an eDRX cycle longer than the SI modification period, a paging message including systemInfoModification-eDRX may be used to notify SI changes.

In LTE, the UE may be configured with eDRX including an eDRX cycle (T_{eDRX}) by the NAS. The UE may operate with eDRX only when the UE is configured with eDRX by the NAS and when the serving cell indicates that it supports eDRX through SI. If T_{eDRX}=512 radio frames are configured in the UE, the PO may be monitored at T=512 according to the legacy DRX operation (clause 7.1 in TS 36.304). In other cases, the UE configured with eDRX may monitor the PO; 1) according to the legacy DRX operation (e.g. clause 7.1 in TS 36.304) during the periodic PTW or 2) until the reception of a paging message including the NAS identity of the UE (whichever occurs first).

The PTW 720 is UE-specific, and may be determined by 1) the PH 725, 2) the PTW start point (PTW_start) 730 within the PH 725, and 3) the PTW end point (PTW_end) 735. The three PTW determinants described above may be determined as shown below in Table 4. The PTW_end 735 may also indicate the SFN outside the PH 725, which includes the PTW_start 730 depending on the PTW_start 730 and the configured length of the PTW 720.

```
TABLE 4
The PH is the H-SFN satisfying the following:
  H-SFN mod TeDRX,H= (UE_ID_H mod TeDRX,H), where
  - UE_ID_H:
      - 10 most significant bits of the Hashed ID, if P-RNTI is monitored on PDCCH or
MPDCCH
    - 12 most significant bits of the Hashed ID, if P-RNTI is monitored on NPDCCH
  - T_{eDRX,H} : eDRX cycle of the UE in Hyper-frames, (T_{eDRX,H} =1, 2, .. , 256 Hyper-
frames) (for NB-IoT, T_{eDRX,H} =2, .., 1024 Hyper-frames) and configured by upper
layers.
PTW_start denotes the first radio frame of the PH that is part of the PTW and has SFN
satisfying the following equation:
  SFN = 256* i_{eDRX}, where
  - i_{eDRX} = floor(UE_ID_H /T_{eDRX,H}) mod 4
PTW_end is the last radio frame of the PTW and has SFN satisfying the following
equation:
  SFN = (PTW_start + L*100 − 1) mod 1024, where
  - L = PTW length (in seconds) configured by upper layers
Hashed ID is defined as follows:
Hashed_ID is frame check sequence (FCS) for the bits b31, b30, .., b0 of S-TMSI or
5G-S-TMSI. 5G-S-TMSI is used for Hashed-ID if the UE supports connection to 5GC
and NAS indicated to use 5GC for the selected cell.
S-TMSI = <b39, b38, .., b0> as defined in TS 23.003 [35]
5G-S-TMSI = <b47, b46, .., b0> as defined in TS 23.003 [35].
The 32-bit FCS shall be the ones complement of the sum (modulo 2) of Y1 and Y2,
where
  - Y1 is the remainder of x^{k} (x³¹ + x³⁰ + x²⁹ + x²⁸ + x²⁷ + x²⁶ + x²⁵ + x²⁴ + x²³ + x²² +
x²¹ + x²⁰ + x¹⁹ + x¹⁸ + x¹⁷ + x¹⁶ + x¹⁵ + x¹⁴ + x¹³ + x¹² + x¹¹ + x¹⁰ + x⁹ + x⁸ + x⁷ + x⁶ +
x⁵ + x⁴ + x³ + x² + x¹ + 1) divided (modulo 2) by the generator polynomial x³² + x²⁶ +
x²³ + x²² + x¹⁶ + x¹² + x¹¹ + x¹⁰ + x⁸ + x⁷ + x⁵ + x⁴ + x² + x + 1, where k is 32; and
  - Y2 is the remainder of Y3 divided (modulo 2) by the generator polynomial x³² +
x²⁶ + x²³ + x²² + x¹⁶ + x¹² + x¹¹ + x¹⁰ + x⁸ + x⁷ + x⁵ + x⁴ + x² + x + 1, where Y3 is the
product of x³² by “b31, b30, .., b0 of S-TMSI or 5G-S-TMSI”, i.e., Y3 is the generator
polynomial x³² (b31*x³¹ + b30*x³⁰ + .. + b0*1).
NOTE: The Y1 is 0xC704DD7B for any S-TMSI or 5G-S-TMSI value.
```

In LTE, the UE configured with eDRX may monitor the PO in the cycle indicated in the description below depending on the UE's RRC state and whether the UE is inside or outside the PTW, depending on the T_{eDRX} configuration (e.g., 620), and whether the camped cell supports eDRX (e.g., 635). (rf=radio frame, UE specific cycle=UE specific CN paging cycle, Default cycle=Default CN paging cycle)
1. The UE in the RRC_IDLE may determine the paging monitoring cycle (T_{DRX_IDLE,LTE}) depending on three cases (Case 1_{IDLE,LTE}, Case 2_{IDLE,LTE}, and Case 3_{IDLE,LTE}) as follows.

It is noted that min indicates a function that outputs the minimum value only for the values configured for the UE from among input values.
Case 1_{IDLE,LTE}) When T_{eDRX} is not configured or the camped cell does not allow eDRX
   T_{DRX_IDLE,LTE}=min (UE specific paging cycle, Default paging cycle)
Case 2_{IDLE,LTE}) When T_{eDRX}=512rf (=5.12 seconds) is configured and the camped cell allows eDRX
   T_{DRX_IDLE,LTE}=T_{eDRX}=5.12 seconds
Case 3_{IDLE,LTE}) When T_{eDRX}≠512rf (=5.12 seconds) is configured and the camped cell allows eDRX
   Inside the PTW, T_{DRX_IDLE,LTE}=min (UE specific paging cycle, Default paging cycle)
   Outside the PTW, the UE may not monitor paging.
2. The UE in the RRC_INACTIVE may determine the paging monitoring cycle (T_{DRX_INACTIVE,LTE}) according to three cases (Case 1_{INACTIVE,LTE}, Case 2_{INACTIVE,LTE}, and Case 3_{INACTIVE,LTE}) as follows.
Case 1_{INACTIVE,LTE}) When T_{eDRX} is not configured or the camped cell does not allow eDRX
   T_{DRX_INACTIVE,LTE}=min (UE specific paging cycle, Default paging cycle, RAN paging cycle)
Case 2_{INACTIVE,LTE}) When T_{eDRX}=512rf (=5.12 seconds) is configured and the camped cell allows eDRX
   T_{DRX_INACTIVE,LTE}=min (T_{eDRX} (=5.12 seconds), RAN paging cycle)
Case 3_{INACTIVE,LTE}) When T_{eDRX}≠512rf (=5.12 seconds) is configured and the camped cell allows eDRX
   inside the PTW, T_{DRX_INACTIVE,LTE}=min (UE specific paging cycle, Default paging cycle, RAN paging cycle)
   Outside the PTW, T_{DRX_INACTIVE,LTE}=RAN paging cycle

The above determination of the paging monitoring cycles (paging monitoring cycle and DRX cycle) in LTE may be summarized as shown in Table 5 and Table 6 below.

TABLE 5
UE in the RRC_IDLE mode

| | | |
|---|---|---|
| 1) T_{eDRX} is not | 1) T_{eDRX} = 5.12 s and | 1) T_{eDRX} ≠ 5.12 s and |
| configured, or | 2) eDRX-Allowed is | 2) eDRX-Allowed is |
| 2) eDRX-Allowed is | present in SIB | present in SIB |
| absent in SIB | | |
| min (UE specific, | T_{eDRX} = 5.12 s | During PTW, min (UE |
| default) | | specific, default) |
| | | Outside PTW, No |
| | | monitoring |

TABLE 6
UE in the RRC_INACTIVE mode

| | | |
|---|---|---|
| 1) T_{eDRX} is not | 1) T_{eDRX} = 5.12 s and | 1) T_{eDRX} ≠ 5.12 s and |
| configured or | 2) eDRX-Allowed is | 2) eDRX-Allowed is |
| 2) eDRX-Allowed is | present in SIB | present in SIB |
| absent in SIB | | |
| min (UE specific, | min (T_{eDRX}(=5.12 s), | During PTW, min (UE |
| default, RAN) | RAN) | specific, default, |
| | | RAN) Outside PTW, RAN |

In NR Release (Rel) 17, unlike the eDRX configuration in LTE, the conventional T_{eDRX} may be classified into an eDRX cycle for UE in the RRC_IDLE (=T_{eDRX_IDLE}) and an eDRX cycle for UE in the RRC_INACTIVE (=T_{eDRX_INACTIVE}). Since T_{eDRX_IDLE} may be configured by the CN, it may also be expressed as T_{eDRX_CN}. Since T_{eDRX_INACTIVE} may be configured by the RAN (BS), it may also be expressed as T_{eDRX_RAN}. In addition, in Release 17 NR, the cycle (DRX cycle) in which the UE in the RRC_IDLE and RRC_INACTIVE monitors paging may be determined depending on the configuration of T_{eDRX_IDLE} and T_{eDRX_INACTIVE} and depending on whether the camped cell supports eDRX (eDRX-AllowedIdle or eDRX-AllowedInactive) (e.g., 635) as follows.
1. The UE in the RRC_IDLE may determine the paging monitoring cycle (T_{DRX_IDLE,NR}) depending on three cases (Case 1_{IDLE,NR}, Case 2_{IDLE,NR}, and Case 3_{IDLE,NR}) as follows.

It is noted that min indicates a function that outputs the minimum value only for the values configured for the UE from among input values.
Case 1_{IDLE,NR}) When T_{eDRX_IDLE} is not configured
   T_{DRX_IDLE,NR}=min (UE specific paging cycle, Default paging cycle)
Case 2_{IDLE,NR}) When T_{eDRX_IDLE}≤10.24 seconds is configured
   If eDRX-AllowedIdle is configured, T_{DRX_IDLE,NR}=T_{eDRX_IDLE}
   If eDRX-AllowedIdle is not configured, T_{DRX_IDLE,NR}=min (UE specific paging cycle, Default paging cycle)
Case 3_{IDLE,NR}) When T_{eDRX_IDLE}>10.24 seconds is configured
   If eDRX-AllowedIdle is configured,
   Inside the PTW_IDLE, T_{DRX_IDLE,NR}=min (UE specific paging cycle, Default paging cycle)
   Outside the PTW_IDLE, the UE may not monitor paging.

It is noted that in Rel 17, PTW_IDLE is defined only when T_{eDRX_IDLE}>10.24 seconds and occurs every T_{eDRX_IDLE}.
2. The UE in the RRC_INACTIVE may determine the paging monitoring cycle (T_{DRX_INACTIVE,NR}) depending on five cases (Case 1_{INACTIVE,NR}, Case 2_{INACTIVE,NR}, Case 3_{INACTIVE,NR}, Case 4_{INACTIVE,NR}, and Case 5_{INACTIVE,NR}) as follows.
Case 1_{INACTIVE,NR}) When T_{eDRX_IDLE} is not configured and T_{eDRX_INACTIVE} is also not configured
   T_{DRX_INACTIVE,NR}=min (UE specific paging cycle, Default paging cycle, RAN paging cycle)
Case 2_{INACTIVE,NR}) When T_{eDRX_IDLE}≤10.24 seconds is configured and T_{eDRX_INACTIVE} is not configured
   If eDRX-AllowedIdle is configured, T_{DRX_INACTIVE,NR}=min (T_{eDRX_IDLE}, RAN paging cycle)
   If eDRX-AllowedIdle is not configured, T_{DRX_INACTIVE,NR}=min (UE specific paging cycle, Default paging cycle, RAN paging cycle)
Case 3_{INACTIVE,NR}) When T_{eDRX_IDLE}≤10.24 seconds is configured and T_{eDRX_INACTIVE}≤10.24 seconds is configured
   If eDRX-AllowedIdle is configured and eDRX-AllowedInactive is configured, T_{DRX_INACTIVE,NR}=min (T_{eDRX_IDLE}, T_{eDRX_INACTIVE})
   If eDRX-AllowedIdle is configured and eDRX-AllowedInactive is not configured, T_{DRX_INACTIVE,NR}=min (T_{eDRX_IDLE}, RAN paging cycle)
   If eDRX-AllowedIdle is not configured and eDRX-AllowedInactive is not configured, T_{DRX_INACTIVE,NR}=min (UE specific paging cycle, Default paging cycle, RAN paging cycle)
Case 4_{INACTIVE,NR}) When T_{eDRX_IDLE}>10.24 seconds is configured and T_{eDRX_INACTIVE} is not configured
   If eDRX-AllowedIdle is configured,
   Inside the PTW, T_{DRX_INACTIVE,NR}=min (UE specific paging cycle, Default paging cycle, RAN paging cycle)
   Outside the PTW, T_{DRX_INACTIVE,NR}=RAN paging cycle
   If eDRX-AllowedIdle is not configured,
   T_{DRX_INACTIVE,NR}=min (UE specific paging cycle, Default paging cycle, RAN paging cycle)
Case 5_{INACTIVE,NR}) When T_{eDRX_IDLE}>10.24 seconds is configured and T_{eDRX_INACTIVE}≤10.24 seconds is configured
   If eDRX-AllowedIdle is configured and eDRX-AllowedInactive is configured,
   Inside the PTW, T_{DRX_INACTIVE,NR}=min (UE specific paging cycle, Default paging cycle, T_{eDRX_INACTIVE})
   Outside the PTW, T_{DRX_INACTIVE,NR}=T_{eDRX_INACTIVE}
   If eDRX-AllowedIdle is configured and eDRX-AllowedInactive is not configured,
   Inside the PTW, T_{DRX_INACTIVE,NR}=min (UE specific paging cycle, Default paging cycle, RAN paging cycle)
   Outside the PTW, T_{DRX_INACTIVE,NR}=RAN paging cycle
   If eDRX-AllowedIdle is not configured and eDRX-AllowedInactive is not configured, T_{DRX_INACTIVE,NR}=min (UE specific paging cycle, Default paging cycle, RAN paging cycle)

T_{eDRX_INACTIVE}>10.24 seconds may be supported/defined to reduce energy consumption of the UE in the inactive mode. In this case, a PTW separate from PTW_IDLE may be defined (e.g., PTW_INACTIVE). PTW_IDLE information (e.g., PTW_IDLE length) is a value configured by the CN or AMF, and the UE may monitor CN paging in the cycle of min (UE specific paging cycle, Default paging cycle) inside PTW_IDLE and may not monitor CN paging outside PTW_IDLE. Similarly, PTW_INACTIVE information (e.g., PTW_INACTIVE length) may be a value configured by the RAN or BS, and the UE may monitor RAN paging in the RAN paging cycle inside PTW_INACTIVE and may not monitor RAN paging outside PTW_INACTIVE.

An indicator with which the BS supports or allows eDRX operation when T_{eDRX_INACTIVE}>10.24 seconds may be defined in the SIB (e.g., 635) (e.g., eDRX-AllowedInactive-long). For example, the BS may indicate whether to support or allow eDRX in the idle mode by including or omitting eDRX-AllowedIdle in or from the SIB, indicate whether to support or allow eDRX in the inactive mode in the cycle of T_{eDRX_INACTIVE}≤10.24 seconds by including or omitting eDRX-AllowedInactive in or from the SIB, and indicate whether to support or allow eDRX in the inactive mode in the cycle of T_{eDRX_INACTIVE}>10.24 seconds by including or omitting eDRX-AllowedInactive-long in or from the SIB.

Herein, if T_{eDRX_INACTIVE}>10.24 seconds is supported (e.g., Release 18 NR), the paging monitoring cycle of the UE in the inactive mode may be determined differently depending on the SIB indicators (e.g., eDRX-AllowedIdle, eDRX-AllowedInactive, and eDRX-AllowedInactive-long), as well as T_{eDRX_IDLE}/T_{eDRX_INACTIVE} configurations.

In Case 1-1, when the UE
1) is configured with T_{eDRX_IDLE}>10.24 seconds by the CN or AMF (620),
2) is configured with T_{eDRX_INACTIVE}>10.24 seconds by the BS (625), and
3) where a cell camped on when the UE is in the inactive mode includes/includes/includes three SIB indicators (eDRX-AllowedIdle eDRX-AllowedInactive eDRX-AllowedInactive-long), respectively (635),
since the UE is configured with idle mode eDRX according to T_{eDRX_IDLE}>10.24 seconds and is allowed to perform the operation according thereto in the corresponding cell, the UE may perform a idle mode eDRX operation at T_{eDRX_IDLE}>10.24 seconds. The UE may monitor CN paging in the cycle of min (Default paging cycle, UE specific paging cycle) only for configured values inside PTW_IDLE and may not monitor CN paging outside PTW_IDLE. In addition, since the UE is configured with inactive mode eDRX according to T_{eDRX_INACTIVE}>10.24 seconds and is allowed to perform the operation according thereto in the corresponding cell, the UE may perform an inactive mode eDRX operation at T_{eDRX_INACTIVE}>10.24 seconds. The UE may monitor RAN paging in the RAN paging cycle only for configured values inside PTW_INACTIVE, and may not monitor RAN paging outside PTW_INACTIVE. Therefore, the paging monitoring cycle 640 of the UE in the inactive mode may be as follows (only for configured values).
1) Inside PTW_IDLE and inside PTW_INACTIVE,
min (Default paging cycle, UE specific paging cycle, RAN paging cycle)
2) Inside PTW_IDLE and outside PTW_INACTIVE,
min (Default paging cycle, UE specific paging cycle)
3) Outside PTW_IDLE and inside PTW_INACTIVE,
RAN paging cycle
4) Outside PTW_IDLE and outside PTW_INACTIVE,

The UE may not perform paging monitoring.

In Case 1-2, when the UE
1) is configured with T_{eDRX_IDLE}>10.24 seconds by CN or AMF,
2) is configured with T_{eDRX_INACTIVE}>10.24 seconds by the BS, and
3) where a cell camped on when the UE is in the inactive mode includes/does not include/does not include three SIB indicators (eDRX-AllowedIdle eDRX-AllowedInactive eDRX-AllowedInactive-long), respectively,
since the UE is configured with idle mode eDRX according to T_{eDRX_IDLE}>10.24 seconds and is allowed to perform the operation according thereto in the corresponding cell, the UE may perform a idle mode eDRX operation at T_{eDRX_IDLE}>10.24 seconds. The UE may monitor CN paging in the cycle of min (Default paging cycle, UE specific paging cycle) only for configured values inside PTW_IDLE, and may not monitor CN paging outside PTW_IDLE. However, since the UE is configured with inactive mode eDRX according to T_{eDRX_INACTIVE}>10.24 seconds but is not allowed to perform the operation according thereto in the corresponding cell, the UE may be unable to perform the inactive mode eDRX operation at T_{eDRX_INACTIVE}>10.24 seconds. The UE may always (regardless of the section according to PTW_INACTIVE) monitor RAN paging in the RAN paging cycle. Therefore, the paging monitoring cycle 640 of the UE in the inactive mode may be as follows (only for configured values).
1) Inside PTW_IDLE
min (Default paging cycle, UE specific paging cycle, RAN paging cycle)
2) Outside PTW_IDLE,
RAN paging cycle

In Case 1-3, when the UE
1) is configured with T_{eDRX_IDLE}>10.24 seconds by the CN or AMF,
2) is configured with T_{eDRX_INACTIVE}>10.24 seconds by the BS, and
3) where a cell camped on when the UE is in the inactive mode includes/includes/does not include three SIB indicators (eDRX-AllowedIdle/eDRX-AllowedInactive/eDRX-AllowedInactive-long), respectively,
since the UE is configured with idle mode eDRX according to T_{eDRX_IDLE}>10.24 seconds and is allowed to perform the operation according thereto in the corresponding cell, the UE may perform a idle mode eDRX operation at T_{eDRX_IDLE}>10.24 seconds. The UE may monitor CN paging in the cycle of min (Default paging cycle, UE specific paging cycle) only for configured values inside PTW_IDLE and may not monitor CN paging outside PTW_IDLE. However, since the UE is configured with inactive mode eDRX according to T_{eDRX_INACTIVE}>10.24 seconds but is not allowed to perform the operation according thereto in the corresponding cell, the UE may be unable to perform the inactive mode eDRX operation at T_{eDRX_INACTIVE}>10.24 seconds. The UE may monitor RAN paging in the cycle according to one of the following options.

Option 1) The UE may always (regardless of the section according to PTW_INACTIVE) monitor RAN paging in the RAN paging cycle.

Option 2) Option 2 is based on the assumption that the UE may be configured with both T_{eDRX_INACTIVE}>10.24 seconds (e.g., ran-ExtendedPagingCycle in the RRCRelease message) and T_{eDRX_INACTIVE}≤10.24 seconds (e.g., ran-ExtendedPagingCycle-long in the RRCRelease message) by the BS.

If the UE is configured with both T_{eDRX_INACTIVE}>10.24 seconds and T_{eDRX_INACTIVE}≤ 10.24 seconds, the UE is unable to use T_{eDRX_INACTIVE}>10.24 seconds in the corresponding cell but may reduce energy consumption for RAN paging monitoring using T_{eDRX_INACTIVE}≤10.24 seconds separately configured, instead of using a RAN paging cycle.

If the UE is not configured with both T_{eDRX_INACTIVE}>10.24 seconds and T_{eDRX_INACTIVE}≤ 10.24 seconds, the UE may monitor RAN paging in the RAN paging cycle.

Option 3) Although the UE is unable to use T_{eDRX_INACTIVE}>10.24 seconds configured in the corresponding cell, since the cell allows T_{eDRX_INACTIVE}≤10.24 seconds, the UE may monitor RAN paging in the cycle of 10.24 seconds. That is, 10.24 seconds, which is the greatest value in the range of T_{eDRX_INACTIVE}≤10.24 seconds allowed to reduce energy consumption as much as possible, may be used.

Therefore, the paging monitoring cycle 640 of the UE in the inactive mode may be as follows (only for configured values).

When Option 1
1) Inside PTW_IDLE
   min (Default paging cycle, UE specific paging cycle, RAN paging cycle)
2) Outside PTW_IDLE,
   RAN paging cycle
   When using Option 2

If T_{eDRX_INACTIVE}≤10.24 seconds is configured,
1) Inside PTW_IDLE
   min (Default paging cycle, UE specific paging cycle, T_{eDRX_INACTIVE} (≤10.24 seconds))
2) Outside PTW_IDLE,
   T_{eDRX_INACTIVE} (≤10.24 seconds)

If T_{eDRX_INACTIVE}≤10.24 seconds is not configured,
1) Inside PTW_IDLE
   min (Default paging cycle, UE specific paging cycle, RAN paging cycle)
2) Outside PTW_IDLE,
   RAN paging cycle
   When using Option 3
1) Inside PTW_IDLE
   min (Default paging cycle, UE specific paging cycle, 10.24 seconds)
2) Outside PTW_IDLE,
   10.24 seconds

In Case 1-4, when the UE
1) is configured with T_{eDRX_IDLE}>10.24 seconds by the CN or AMF, and
2) is configured with T_{eDRX_INACTIVE}>10.24 seconds by the BS, and
3) where a cell camped on when the UE is in the inactive mode includes/does not include/includes three SIB indicators (eDRXAllowedIdle/eDRXAllowedInactive/eDRXAllowedInactivelong), respectively (635),
since the UE is configured with idle mode eDRX according to T_{eDRX_IDLE}>10.24 seconds and is allowed to perform the operation according thereto in the corresponding cell, the UE may perform a idle mode eDRX operation at T_{eDRX_IDLE}>10.24 seconds. The UE may monitor CN paging in the cycle of min (Default paging cycle, UE specific paging cycle) only for configured values inside PTW_IDLE and may not monitor CN paging outside PTW_IDLE. In addition, since the UE is configured with inactive mode eDRX according to T_{eDRX_INACTIVE}>10.24 seconds and is allowed to perform the operation according thereto in the corresponding cell, the UE may perform an inactive mode eDRX operation at T_{eDRX_INACTIVE}>10.24 seconds. The UE may monitor RAN paging in the RAN paging cycle inside PTW_INACTIVE only for configured values, and may not monitor RAN paging outside PTW_INACTIVE. Therefore, the paging monitoring cycle of the UE in the inactive mode may be as follows (only for configured values).
1) Inside PTW_IDLE and inside PTW_INACTIVE,
min (Default paging cycle, UE specific paging cycle, RAN paging cycle)
2) Inside PTW_IDLE and outside PTW_INACTIVE,
min (Default paging cycle, UE specific paging cycle)
3) Outside PTW_IDLE and inside PTW_INACTIVE,
RAN paging cycle
4) Outside PTW_IDLE and outside PTW_INACTIVE,

The UE may not perform paging monitoring.

In Case 1-5, when the UE
1) is configured with T_{eDRX_IDLE}>10.24 seconds by the CN or AMF, and
2) is configured with T_{eDRX_INACTIVE}>10.24 seconds by the BS, and
3) where a cell camped on when the UE is in the inactive mode does not include/does not include/does not include the three SIB indicators (eDRX-AllowedIdle eDRX-AllowedInactive eDRX-AllowedInactive-long), respectively (635),
since the UE is configured with idle mode eDRX according to T_{eDRX_IDLE}>10.24 seconds but is not allowed to perform the operation according thereto in the corresponding cell, the UE may not perform a idle mode eDRX operation at T_{eDRX_IDLE}>10.24 seconds. That is, the UE may always (regardless of the section according to PTW_IDLE) monitor CN paging in the cycle of min (Default paging cycle, UE specific paging cycle). In addition, since the UE is configured with inactive mode eDRX according to T_{eDRX_INACTIVE}>10.24 seconds but is not allowed to perform the operation according thereto in the corresponding cell, the UE may be unable to perform the inactive mode eDRX operation at T_{eDRX_INACTIVE}>10.24 seconds. In other words, the UE may always, regardless of the section according to PTW_INACTIVE, monitor RAN paging in the RAN paging cycle. Therefore, the paging monitoring cycle of the UE in the inactive mode may be as follows (only for configured values).
min (Default paging cycle, UE specific paging cycle, RAN paging cycle)

In Case 1-6, when the UE
1) is configured with T_{eDRX_IDLE}>10.24 seconds by the CN or AMF,
2) is configured with T_{eDRX_INACTIVE}>10.24 seconds by the BS, and
3) where a cell camped on when the UE is in the inactive mode includes/includes two SIB indicators (eDRX-AllowedIdle and eDRX-AllowedInactive-long), respectively,
since the UE is configured with idle mode eDRX according to T_{eDRX_IDLE}>10.24 seconds and is allowed to perform the operation according thereto in the corresponding cell, the UE may perform a idle mode eDRX operation at T_{eDRX_IDLE}>10.24 seconds. The UE may monitor CN paging inside PTW_IDLE in the cycle of min (Default paging cycle, UE specific paging cycle) only for configured values, and may not monitor CN paging outside PTW_IDLE. In addition, since the UE is configured with inactive mode eDRX according to T_{eDRX_INACTIVE}>10.24 seconds and is allowed to perform the operation according thereto in the corresponding cell, the UE may perform an inactive mode eDRX operation at T_{eDRX_INACTIVE}>10.24 seconds. The UE may monitor RAN paging in the RAN paging cycle inside PTW_INACTIVE only for configured values, and may not monitor RAN paging outside PTW_INACTIVE. Therefore, the paging monitoring cycle of the UE in the inactive mode may be as follows (only for configured values).
1) Inside PTW_IDLE and inside PTW_INACTIVE,
min (Default paging cycle, UE specific paging cycle, RAN paging cycle)
2) Inside PTW_IDLE and outside PTW_INACTIVE,
min (Default paging cycle, UE specific paging cycle)
3) Outside PTW_IDLE and inside PTW_INACTIVE,
RAN paging cycle
4) Outside PTW_IDLE and outside PTW_INACTIVE;

The UE may not perform paging monitoring.

In Case 1-7, when the UE
1) is configured with T_{eDRX_IDLE}>10.24 seconds by the CN or AMF,
2) is configured with T_{eDRX_INACTIVE}>10.24 seconds by the BS, and
3) where a cell camped on when the UE is in the inactive mode includes/does not include two SIB indicators (eDRX-AllowedIdle eDRX-AllowedInactive-long), respectively,
since the UE is configured with idle mode eDRX according to T_{eDRX_IDLE}>10.24 seconds and is allowed to perform the operation according thereto in the corresponding cell, the UE may perform a idle mode eDRX operation at T_{eDRX_IDLE}>10.24 seconds. The UE may monitor CN paging in the cycle of min (Default paging cycle, UE specific paging cycle) only for configured values inside PTW_IDLE and may not monitor CN paging outside PTW_IDLE. However, since the UE is configured with inactive mode eDRX according to T_{eDRX_INACTIVE}>10.24 seconds but is not allowed to perform the operation according thereto in the corresponding cell, the UE may be unable to perform the inactive mode eDRX operation at T_{eDRX_INACTIVE}>10.24 seconds. In other words, the UE may always, regardless of the section according to PTW_INACTIVE, monitor RAN paging in the RAN paging cycle. Therefore, the paging monitoring cycle 640 of the UE in the inactive mode may be as follows (only for configured values).
1) Inside PTW_IDLE
min (Default paging cycle, UE specific paging cycle, RAN paging cycle)
2) Outside PTW_IDLE,
RAN paging cycle

In Case 2-1, when the UE
1) is configured with T_{eDRX_IDLE}≤10.24 seconds by the CN or AMF,
2) is configured with T_{eDRX_INACTIVE}>10.24 seconds by the BS, and
3) where a cell camped on when the UE is in the inactive mode includes/includes/includes three SIB indicators (eDRX-AllowedIdle eDRX-AllowedInactive eDRX-AllowedInactive-long), respectively,
since the UE is configured with idle mode eDRX according to T_{eDRX_IDLE}≤10.24 seconds and is allowed to perform the operation according thereto in the corresponding cell, the UE may perform a idle mode eDRX operation at T_{eDRX_IDLE}≤10.24 seconds. In other words, the UE may always, regardless of the section according to PTW_IDLE, monitor CN paging in the T_{eDRX_IDLE} cycle only for configured values. In addition, since the UE is configured with inactive mode eDRX according to T_{eDRX_INACTIVE}>10.24 seconds and is allowed to perform the operation according thereto in the corresponding cell, the UE may perform an inactive mode eDRX operation at T_{eDRX_INACTIVE}>10.24 seconds. That is, the UE may monitor RAN paging in the RAN paging cycle inside PTW_INACTIVE only for configured values, and may not monitor RAN paging outside PTW_INACTIVE. Therefore, the paging monitoring cycle of the UE in the inactive mode may be as follows (only for configured values).
1) Inside PTW_INACTIVE,
min (T_{eDRX_IDLE}, RAN paging cycle)
2) Outside PTW_INACTIVE,
T_{eDRX_IDLE}

In Case 2-2, when the UE
1) is configured with T_{eDRX_IDLE}≤10.24 seconds by the CN or AMF,
2) is configured with T_{eDRX_INACTIVE}>10.24 seconds by the BS, and
3) where a cell camped on when the UE is in the inactive mode includes/does not include/does not include three SIB indicators (eDRX-AllowedIdle eDRX-AllowedInactive eDRX-AllowedInactive-long), respectively,
since the UE is configured with idle mode eDRX according to T_{eDRX_IDLE}≤10.24 seconds and is allowed to perform the operation according thereto in the corresponding cell, the UE may perform a idle mode eDRX operation at T_{eDRX_IDLE}≤10.24 seconds. In other words, the UE may always, regardless of the section according to PTW_IDLE, monitor CN paging in the T_{eDRX_IDLE} cycle only for configured values. However, since the UE is configured with inactive mode eDRX according to T_{eDRX_INACTIVE}>10.24 seconds but is not allowed to perform the operation according thereto in the corresponding cell, the UE may be unable to perform the inactive mode eDRX operation at T_{eDRX_INACTIVE}>10.24 seconds. In other words, the UE may always, regardless of the section according to PTW_INACTIVE, monitor RAN paging in the RAN paging cycle. Therefore, the paging monitoring cycle of the UE in the inactive mode may be as follows (only for configured values).
min (T_{eDRX_IDLE}, RAN paging cycle)

In Case 2-3, when the UE
1) is configured with T_{eDRX_IDLE}≤10.24 seconds by the CN or AMF,
2) is configured with T_{eDRX_INACTIVE}>10.24 seconds by the BS, and,
3) where a cell camped on when the UE is in the inactive mode includes/includes/does not include three SIB indicators (eDRX-AllowedIdle eDRX-AllowedInactive eDRX-AllowedInactive-long), respectively,
since the UE is configured with idle mode eDRX according to T_{eDRX_IDLE}≤10.24 seconds and is allowed to perform the operation according thereto in the corresponding cell, the UE may perform a idle mode eDRX operation at T_{eDRX_IDLE}≤10.24 seconds. In other words, the UE may always, regardless of the section according to PTW_IDLE, monitor CN paging in the T_{eDRX_IDLE} cycle only for configured values. However, since the UE is configured with inactive mode eDRX according to T_{eDRX_INACTIVE}>10.24 seconds but is not allowed to perform the operation according thereto in the corresponding cell, the UE may be unable to perform the inactive mode eDRX operation at T_{eDRX_INACTIVE}>10.24 seconds. The UE may monitor RAN paging in the cycle according to one of the following options.

Option 1) The UE may always (regardless of the section according to PTW_INACTIVE) monitor RAN paging in the RAN paging cycle.

Option 2) Option 2 is based on the assumption that the UE may be configured with both T_{eDRX_INACTIVE}>10.24 seconds (e.g., ran-ExtendedPagingCycle in the RRCRelease message) and T_{eDRX_INACTIVE}≤10.24 seconds (e.g., ran-ExtendedPagingCycle-long in the RRCRelease message) by the BS.

If the UE is configured with both T_{eDRX_INACTIVE}>10.24 seconds and T_{eDRX_INACTIVE}≤10.24 seconds, the UE is unable to use T_{eDRX_INACTIVE}>10.24 seconds in the corresponding cell but may reduce energy consumption for RAN paging monitoring using T_{eDRX_INACTIVE}≤10.24 seconds separately configured, instead of using RAN paging cycle.

If the UE is not configured with both T_{eDRX_INACTIVE}>10.24 seconds and T_{eDRX_INACTIVE}≤ 10.24 seconds, the UE may monitor RAN paging in the RAN paging cycle.

Option 3) Although the UE is unable to use T_{eDRX_INACTIVE}>10.24 seconds configured in the cell, since the cell allows T_{eDRX_INACTIVE}≤10.24 seconds, the UE may monitor RAN paging in the cycle of 10.24 seconds. That is, 10.24 seconds, which is the greatest value in the range of T_{eDRX_INACTIVE}≤10.24 seconds allowed to reduce energy consumption as much as possible, may be used.

Therefore, the paging monitoring cycle 640 of the UE in the inactive mode may be as follows (only for configured values).
When using Option 1
min (T_{eDRX_IDLE}, RAN paging cycle)
When using Option 2
If T_{eDRX_INACTIVE}≤10.24 seconds is configured,
min (T_{eDRX_IDLE}, T_{eDRX_INACTIVE} (≤10.24 seconds))
If T_{eDRX_INACTIVE}≤10.24 seconds is not configured,
min (T_{eDRX_IDLE}, RAN paging cycle)
When using Option 3
min (T_{eDRX_IDLE}, 10.24 seconds)

In Case 2-4, when the UE
1) is configured with T_{eDRX_IDLE}≤10.24 seconds by the CN or AMF,
2) is configured with T_{eDRX_INACTIVE}>10.24 seconds by the BS, and
3) where a cell camped on when the UE is in the inactive mode includes/does not include/includes three SIB indicators (eDRX-AllowedIdle eDRX-AllowedInactive eDRX-AllowedInactive-long), respectively,
since the UE is configured with idle mode eDRX according to T_{eDRX_IDLE}≤10.24 seconds and is allowed to perform the operation according thereto in the corresponding cell, the UE may perform a idle mode eDRX operation at T_{eDRX_IDLE}≤10.24 seconds. In other words, the UE may always, regardless of the section according to PTW_IDLE, monitor CN paging in the T_{eDRX_IDLE} cycle only for configured values. In addition, since the UE is configured with inactive mode eDRX according to T_{eDRX_INACTIVE}>10.24 seconds and is allowed to perform the operation according thereto in the corresponding cell, the UE may perform an inactive mode eDRX operation at

T_{eDRX_INACTIVE}>10.24 seconds. The UE may monitor RAN paging in the RAN paging cycle inside PTW_INACTIVE only for configured values, and may not monitor RAN paging outside PTW_INACTIVE. Therefore, the paging monitoring cycle 640 of the UE in the inactive mode may be as follows (only for configured values).
1) Inside PTW_INACTIVE,
min (T_{eDRX_IDLE}, RAN paging cycle)
2) Outside PTW_INACTIVE,
T_{eDRX_IDLE}

In Case 2-5, when the UE
1) is configured with T_{eDRX_IDLE}≤10.24 seconds by the CN or AMF,
2) is configured with T_{eDRX_INACTIVE}>10.24 seconds by the BS, and,
3) where a cell camped on when the UE is in the inactive mode does not include/does not include/does not include the three SIB indicators (eDRX-AllowedIdle eDRX-AllowedInactive eDRX-AllowedInactive-long), respectively,
since the UE is configured with idle mode eDRX according to T_{eDRX_IDLE}≤10.24 seconds but is not allowed to perform the operation according thereto in the corresponding cell, the UE may not perform the idle mode eDRX operation at T_{eDRX_IDLE}≤10.24 seconds. That is, the UE may always, regardless of the section according to PTW_IDLE, monitor CN paging in the cycle of min (Default paging cycle, UE specific paging cycle). In addition, since the UE is configured with inactive mode eDRX according to T_{eDRX_INACTIVE}>10.24 seconds but is not allowed to perform the operation according thereto in the corresponding cell, the UE may be unable to perform the inactive mode eDRX operation at T_{eDRX_INACTIVE}>10.24 seconds. In other words, the UE may always, regardless of the section according to PTW_INACTIVE, monitor RAN paging in the RAN paging cycle. Therefore, the paging monitoring cycle of the UE in the inactive mode may be as follows (only for configured values).
min (Default paging cycle, UE specific paging cycle, RAN paging cycle)

In Case 2-6, when the UE
1) is configured with T_{eDRX_IDLE}≤10.24 seconds by the CN or AMF,
2) is configured with T_{eDRX_INACTIVE}>10.24 seconds by the BS, and,
3) where a cell camped on when the UE is in the inactive mode includes/includes two SIB indicators (eDRX-AllowedIdle eDRX-AllowedInactive-long), respectively,
since the UE is configured with idle mode eDRX according to T_{eDRX_IDLE}≤10.24 seconds and is allowed to perform the operation according thereto in the corresponding cell, the UE may perform a idle mode eDRX operation at T_{eDRX_IDLE}≤10.24 seconds. In other words, the UE may always, regardless of the section according to PTW_IDLE, monitor CN paging in the T_{eDRX_IDLE} cycle only for configured values. In addition, since the UE is configured with inactive mode eDRX according to T_{eDRX_INACTIVE}>10.24 seconds and is allowed to perform the operation according thereto in the corresponding cell, the UE may perform an inactive mode eDRX operation at T_{eDRX_INACTIVE}>10.24 seconds. The UE may monitor RAN paging in the RAN paging cycle inside PTW_INACTIVE only for configured values, and may not monitor RAN paging outside PTW_INACTIVE. Therefore, the paging monitoring cycle of the UE in the inactive mode may be as follows (only for configured values).
1) Inside PTW_INACTIVE,
min (T_{eDRX_IDLE}, RAN paging cycle)
2) Outside PTW_INACTIVE,
T_{eDRX_IDLE}

In Case 2-7, when the UE
1) is configured with T_{eDRX_IDLE}≤10.24 seconds by the CN or AMF,
2) is configured with T_{eDRX_INACTIVE}>10.24 seconds by the BS, and,
3) where a cell camped on when the UE is in the inactive mode includes/does not include two SIB indicators (eDRX-AllowedIdle eDRX-AllowedInactive-long), respectively,
since the UE is configured with idle mode eDRX according to T_{eDRX_IDLE}≤10.24 seconds and is allowed to perform the operation according thereto in the corresponding cell, the UE may perform a idle mode eDRX operation at T_{eDRX_IDLE}≤10.24 seconds. In other words, the UE may always, regardless of the section according to PTW_IDLE, monitor CN paging in the T_{eDRX_IDLE} cycle only for configured values. However, since the UE is configured with inactive mode eDRX according to T_{eDRX_INACTIVE}>10.24 seconds but is not allowed to perform the operation according thereto in the corresponding cell, the UE may be unable to perform the inactive mode eDRX operation at T_{eDRX_INACTIVE}>10.24 seconds. In other words, the UE may always, regardless of the section according to PTW_INACTIVE, monitor RAN paging in the RAN paging cycle. Therefore, the paging monitoring cycle of the UE in the inactive mode may be as follows (only for configured values).
min (T_{eDRX_IDLE}, RAN paging cycle)

In Case 3-1, when the UE
1) is not configured with T_{eDRX_IDLE} by the CN or AMF,
2) is configured with T_{eDRX_INACTIVE}>10.24 seconds by the BS, and,
3) where a cell camped on when the UE is in the inactive mode includes/includes/includes three SIB indicators (eDRX-AllowedIdle eDRX-AllowedInactive eDRX-AllowedInactive-long), respectively,
since the UE is not configured with T_{eDRX_IDLE}, the UE may always, regardless of the section according to PTW_IDLE, monitor CN paging in the cycle of min (Default paging cycle, UE specific paging cycle). In addition, since the UE is configured with inactive mode eDRX according to T_{eDRX_INACTIVE}>10.24 seconds and is allowed to perform the operation according thereto in the corresponding cell, the UE may perform an inactive mode eDRX operation at T_{eDRX_INACTIVE}>10.24 seconds. The UE may monitor RAN paging in the RAN paging cycle inside PTW_INACTIVE only for configured values, and may not monitor RAN paging outside PTW_INACTIVE. Therefore, the paging monitoring cycle 640 of the UE in the inactive mode may be as follows (only for configured values).
1) Inside PTW_INACTIVE,
min (Default paging cycle, UE specific paging cycle, RAN paging cycle)
2) Outside PTW_INACTIVE,
min (Default paging cycle, UE specific paging cycle)

In Case 3-2, when the UE
1) is not configured with T_{eDRX_IDLE} by the CN or AMF,
2) is configured with T_{eDRX_INACTIVE}>10.24 seconds by the BS, and
3) where a cell camped on when the UE is in the inactive mode includes/does not include/does not include three SIB indicators (eDRX-AllowedIdle eDRX-AllowedInactive eDRX-AllowedInactive-long), respectively),
since the UE is not configured with T_{eDRX_IDLE}, it may always (regardless of the section according to PTW_IDLE) monitor CN paging in the cycle of min (Default paging cycle, UE specific paging cycle). However, since the UE is configured with inactive mode eDRX according to T_{eDRX_INACTIVE}>10.24 seconds but is not allowed to perform the operation according thereto in the corresponding cell, the UE may be unable to perform the inactive mode eDRX operation at T_{eDRX_INACTIVE}>10.24 seconds. In other words, the UE may always, regardless of the section according to PTW_INACTIVE, monitor RAN paging in the RAN paging cycle. Therefore, the paging monitoring cycle of the UE in the inactive mode may be as follows (only for configured values).
min (Default paging cycle, UE specific paging cycle, RAN paging cycle)

In Case 3-3, when the UE
1) is not configured with T_{eDRX_IDLE} by the CN or AMF,
2) is configured with T_{eDRX_INACTIVE}>10.24 seconds by the BS, and
3) where a cell camped on when the UE is in the inactive mode includes/includes/does not include three SIB indicators (eDRX-AllowedIdle eDRX-AllowedInactive eDRX-AllowedInactive-long), respectively,
since the UE is not configured with T_{eDRX_IDLE}, the UE may always, regardless of the section according to PTW_IDLE, monitor CN paging in the cycle of min (Default paging cycle, UE specific paging cycle). However, since the UE is configured with inactive mode eDRX according to T_{eDRX_INACTIVE}>10.24 seconds but is not allowed to perform the operation according thereto in the corresponding cell, the UE may be unable to perform the inactive mode eDRX operation at T_{eDRX_INACTIVE}>10.24 seconds. The UE may monitor RAN paging in the cycle according to one of the following options.

In Option 1, the UE may always (regardless of the section according to PTW_INACTIVE) monitor RAN paging in the RAN paging cycle.

Option 2 is based on the assumption that the UE may be configured with both T_{eDRX_INACTIVE}>10.24 seconds (e.g., ran-ExtendedPagingCycle in the RRCRelease message) and T_{eDRX_INACTIVE}≤10.24 seconds (e.g., ran-ExtendedPagingCycle-long in the RRCRelease message) by the BS.

If the UE is configured with both T_{eDRX_INACTIVE}>10.24 seconds and T_{eDRX_INACTIVE}≤10.24 seconds (625), the UE is unable to use T_{eDRX_INACTIVE}>10.24 seconds in the corresponding cell but may reduce energy consumption for RAN paging monitoring using T_{eDRX_INACTIVE}≤10.24 seconds separately configured, instead of using RAN paging cycle.

If the UE is not configured with both T_{eDRX_INACTIVE}>10.24 seconds and T_{eDRX_INACTIVE}≤ 10.24 seconds (625), the UE may monitor RAN paging in the RAN paging cycle.

In Option 3, although the UE is unable to use T_{eDRX_INACTIVE}>10.24 seconds configured in the cell, since the cell allows T_{eDRX_INACTIVE}≤10.24 seconds, the UE may monitor RAN paging in the cycle of 10.24 seconds. That is, 10.24 seconds, which is the greatest value in the range of T_{eDRX_INACTIVE}≤10.24 seconds allowed to reduce energy consumption as much as possible, may be used.

Therefore, the paging monitoring cycle of the UE in the inactive mode may be as follows (only for configured values).
When using Option 1
min (Default paging cycle, UE specific paging cycle, RAN paging cycle)
When using Option 2

If T_{eDRX_INACTIVE}≤10.24 seconds is configured,
min (Default paging cycle, UE specific paging cycle, T_{eDRX_INACTIVE} (≤10.24 seconds))

If T_{eDRX_INACTIVE}≤10.24 seconds is not configured,
min (Default paging cycle, UE specific paging cycle, RAN paging cycle)
When using Option 3
min (Default paging cycle, UE specific paging cycle, 10.24 seconds)

In Case 3-4, when the UE
1) is not configured with T_{eDRX_IDLE} by the CN or AMF,
2) is configured with T_{eDRX_INACTIVE}>10.24 seconds by the BS, and
3) where a cell camped on when the UE is in the inactive mode includes/does not include/includes three SIB indicators (eDRX-AllowedIdle eDRX-AllowedInactive eDRX-AllowedInactive-long), respectively,
since the UE is not configured with T_{eDRX_IDLE}, it may always (regardless of the section according to PTW_IDLE) monitor CN paging in the cycle of min (Default paging cycle, UE specific paging cycle). In addition, since the UE is configured with inactive mode eDRX according to T_{eDRX_INACTIVE}>10.24 seconds and is allowed to perform the operation according thereto in the corresponding cell, the UE may perform an inactive mode eDRX operation at T_{eDRX_INACTIVE}>10.24 seconds. The UE may monitor RAN paging in the RAN paging cycle inside PTW_INACTIVE only for configured values, and may not monitor RAN paging outside PTW_INACTIVE. Therefore, the paging monitoring cycle 640 of the UE in the inactive mode may be as follows (only for configured values).
1) Inside PTW_INACTIVE,
min (Default paging cycle, UE specific paging cycle, RAN paging cycle)
2) Outside PTW_INACTIVE,
min (Default paging cycle, UE specific paging cycle)

In Case 3-5, when the UE
1) is not configured with T_{eDRX_IDLE} by the CN or AMF,
2) is configured with T_{eDRX_INACTIVE}>10.24 seconds by the BS, and
3) where a cell camped on when the UE is in the inactive mode does not include/does not include/does not include the three SIB indicators (eDRX-AllowedIdle eDRX-AllowedInactive eDRX-AllowedInactive-long), respectively,
since the UE is not configured with T_{eDRX_IDLE}, it may always (regardless of the section according to PTW_IDLE) monitor CN paging in the cycle of min (Default paging cycle, UE specific paging cycle). In addition, since the UE is configured with inactive mode eDRX according to T_{eDRX_INACTIVE}>10.24 seconds but is not allowed to perform the operation according thereto in the corresponding cell, the UE may be unable to perform the inactive mode eDRX operation at T_{eDRX_INACTIVE}>10.24 seconds. In other words, the UE may always, regardless of the section according to PTW_INACTIVE, monitor RAN paging in the RAN paging cycle. Therefore, the paging monitoring cycle of the UE in the inactive mode may be as follows (only for configured values).
min (Default paging cycle, UE specific paging cycle, RAN paging cycle)

In Case 3-6, when the UE
1) is not configured with T_{eDRX_IDLE} by the CN or AMF,
2) is configured with T_{eDRX_INACTIVE}>10.24 seconds by the BS, and
3) where a cell camped on when the UE is in the inactive mode includes/includes two SIB indicators (eDRX-AllowedIdle eDRX-AllowedInactive-long), respectively,
since the UE is not configured with T_{eDRX_IDLE}, the UE may always, regardless of the section according to PTW_IDLE, monitor CN paging in the cycle of min (Default paging cycle, UE specific paging cycle). In addition, since the UE is configured with inactive mode eDRX according to T_{eDRX_INACTIVE}>10.24 seconds and is allowed to perform the operation according thereto in the corresponding cell, the UE may perform an inactive mode eDRX operation at T_{eDRX_INACTIVE}>10.24 seconds. The UE may monitor RAN paging in the RAN paging cycle inside PTW_INACTIVE only for configured values, and may not monitor RAN paging outside PTW_INACTIVE. Therefore, the paging monitoring cycle of the UE in the inactive mode may be as follows (only for configured values).
1) Inside PTW_INACTIVE,
min (Default paging cycle, UE specific paging cycle, RAN paging cycle)
2) Outside PTW_INACTIVE,
min (Default paging cycle, UE specific paging cycle)

In Case 3-7, when the UE
1) is not configured with T_{eDRX_IDLE} by the CN or AMF,
2) is configured with T_{eDRX_INACTIVE}>10.24 seconds by the BS, and
3) where a cell camped on when the UE is in the inactive mode includes/does not include two SIB indicators (eDRX-AllowedIdle eDRX-AllowedInactive-long), respectively,
since the UE is not configured with T_{eDRX_IDLE}, the UE may always, regardless of the section according to PTW_IDLE, monitor CN paging in the cycle of min (Default paging cycle, UE specific paging cycle). However, since the UE is configured with inactive mode eDRX according to T_{eDRX_INACTIVE}>10.24 seconds but is not allowed to perform the operation according thereto in the corresponding cell, the UE may be unable to perform the inactive mode eDRX operation at T_{eDRX_INACTIVE}>10.24 seconds. In other words, the UE may always, regardless of the section according to PTW_INACTIVE, monitor RAN paging in the RAN paging cycle. Therefore, the paging monitoring cycle 640 of the UE in the inactive mode may be as follows (only for configured values).
min (Default paging cycle, UE specific paging cycle, RAN paging cycle)

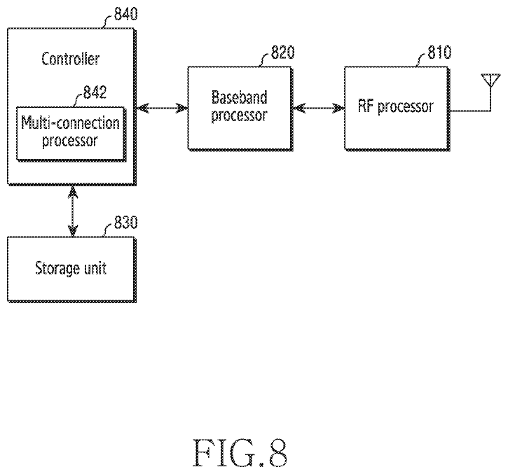

FIG. 8 illustrates a UE device according to an embodiment.

Referring to FIG. 8, the UE may include a radio frequency (RF) processor 810, a baseband processor 820, a storage unit 830, and a controller 840. The configurations of the UE are not limited to the examples shown in FIG. 8 and may include fewer or more configurations than the those shown in FIG. 8.

The RF processor 810 may perform a function of transmitting and receiving a signal through a wireless channel, such as band conversion and amplification of a signal. That is, the RF processor 810 may up-convert a baseband signal provided from the baseband processor 820 to an RF band signal, thereby transmitting the same through an antenna, and down-convert an RF band signal received through the antenna to a baseband signal.

For example, the RF processor 810 may include a transmission filter, a reception filter, an amplifier, a mixer, an oscillator, a digital-to-analog converter (DAC), an analog-to-digital converter (ADC), and the like, but is not limited to such examples. The UE may have a plurality of antennas and a plurality of RF chains. The RF processor 810 may perform beamforming. To perform beamforming, the RF processor 810 may adjust the phases and magnitudes of signals transmitted and received through a plurality of antennas or antenna elements. In addition, the RF processor 810 may perform MIMO, and may receive multiple layers when performing the MIMO operation.

The baseband processor 820 may perform a function of conversion between a baseband signal and a bit string according to the physical layer specification of the system. For example, in the case of data transmission, the baseband processor 820 may encode and modulate transmission bit strings, thereby generating complex symbols. Upon receiving data, the baseband processor 820 may demodulate and decode a baseband signal provided from the RF processor 810, thereby recovering reception bit strings.

For example, when an orthogonal frequency division multiplexing (OFDM) scheme is applied, when transmitting data, the baseband processor 820 may generate complex symbols by encoding and modulating transmission bit strings, map the complex symbols with subcarriers, and then configure OFDM symbols through an inverse fast Fourier transform (IFFT) operation and cyclic prefix (CP) insertion. In addition, when receiving data, the baseband processor 820 may divide the baseband signal provided from the RF processor 810 into OFDM symbol units, restore the signals mapped with the subcarriers through a fast Fourier transform (FFT) operation, and then restore reception bit strings through demodulation and decoding.

The baseband processor 820 and the RF processor 810 may transmit and receive signals as described above. Accordingly, the baseband processor 820 and the RF processor 810 may be referred to as a “transmitter”, a “receiver”, a “transceiver”, or a “communication unit”. At least one of the baseband processor 820 and the RF processor 810 may include a plurality of communication modules to support a plurality of different wireless access technologies. In addition, at least one of the baseband processor 820 and the RF processor 810 may include different communication modules for processing signals in different frequency bands. For example, the different wireless access technologies may include a wireless local area network (LAN), a cellular network (e.g., LTE), and the like. In addition, the different frequency bands may include super high frequency (SHF) (e.g., 2.NRHz or NRhz) band and an mmWave (e.g., 60 GHz) band. The UE may transmit and receive signals to and from the BS using the baseband processor 820 and the RF processor 810, and the signals may include control information and data.

The storage unit 830 may store data such as basic programs, application programs, and configuration information for the operation of the UE. For example, the storage unit 830 may store data information such as basic programs, application programs, and configuration information for the operation of the UE, may provide stored data in response to a request from the controller 840, and may store a program to perform the above-described method for eDRX.

The storage unit 830 may be configured as storage media such as read only memory (ROM), random access memory (RAM), hard disks, compact disc (CD)-ROM, and digital versatile disc (DVD), or a combination of the storage media. In addition, the storage unit 830 may be configured as a plurality of memories.

The controller 840 controls the overall operation of the UE. For example, the controller 840 may transmit and receive signals through the baseband processor 820 and the RF processor 810.

In addition, the controller 840 may record and read data in and from the storage unit 830. To this end, the controller 840 may include at least one processor. For example, the controller 840 may include a communication processor (CP) for controlling communication and an application processor (AP) for controlling upper layers such as application programs. In addition, The controller 840 may include a multi-connection processor 842 for performing a process for operation in a multi-connection mode. In addition, at least one element of the UE may be implemented as one chip.

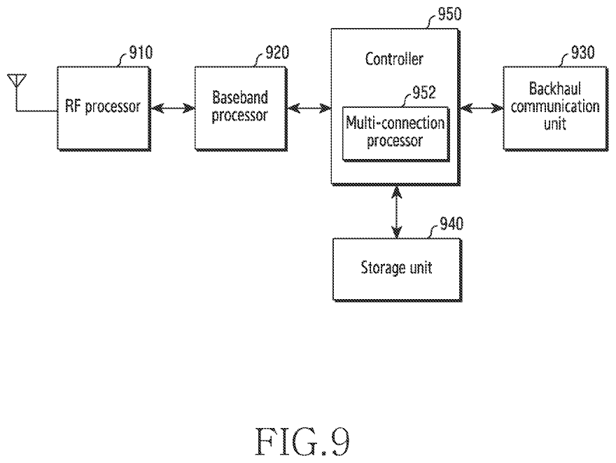

FIG. 9 illustrates a BS device according to an embodiment.

The BS shown in FIG. 9 may be included in the above-described network.

As shown in FIG. 9, the BS may include an RF processor 910, a baseband processor 920, a backhaul communication unit 930, a storage unit 940, and a controller 950. The configurations of the BS are not limited to the examples shown in FIG. 9 and may include fewer or more configurations than the those shown in FIG. 9. The RF processor 910 may perform a function of transmitting and receiving a signal through a wireless channel, such as band conversion and amplification of a signal.

The RF processor 910 may up-convert a baseband signal provided from the baseband processor 920 to an RF band signal, thereby transmitting the same through an antenna, and down-convert an RF band signal received through the antenna to a baseband signal.

The RF processor 910 may include a transmission filter, a reception filter, an amplifier, a mixer, an oscillator, a digital to analog converter (DAC), an analog to digital converter (ADC), and the like. The RF processor 910 may have a plurality of antennas and a plurality of RF chains. The RF processor 910 may perform beamforming. To perform beamforming, the RF processor 910 may adjust the phases and magnitudes of signals transmitted and received through a plurality of antennas or antenna elements. In addition, the RF processor 910 may transmit one or more layers to perform a DL MIMO operation.

The baseband processor 920 may perform a function of conversion between a baseband signal and a bit string according to the physical layer specification of the system. For example, in the case of data transmission, the baseband processor 920 may encode and modulate transmission bit strings, thereby generating complex symbols. Upon receiving data, the baseband processor 920 may demodulate and decode a baseband signal provided from the RF processor 910, thereby recovering reception bit strings. For example, when an OFDM scheme is applied, when transmitting data, the baseband processor 920 may generate complex symbols by encoding and modulating transmission bit strings, map the complex symbols with subcarriers, and then configure OFDM symbols through an IFFT operation and CP insertion. When receiving data, the baseband processor 920 may divide the baseband signal provided from the RF processor 910 into OFDM symbol units, restore the signals mapped with the subcarriers through an FFT operation, and then restore reception bit strings through demodulation and decoding. The baseband processor 920 and the RF processor 910 may transmit and receive signals as described above. Accordingly, the baseband processor 920 and the RF processor 910 may be referred to as a transmitter, a receiver, a transceiver, a communication unit, or a wireless communication unit. The BS may transmit and receive signals to and from the UE using the baseband processor 920 and the RF processor 910, and the signals may include control information and data.

The backhaul communication unit 930 provides an interface for performing communication with other nodes in the network. For example, the backhaul communication unit 930 may convert a bit string, transmitted from the primary BS to another node, such as a secondary BS, a CN, etc., into a physical signal, and convert physical signals received from other nodes into bit strings.

The storage unit 940 may store data such as basic programs, application programs, and configuration information for the operation of the primary BS. For example, the storage unit 940 may store information about bearers assigned to the connected UE, measurement results reported from the connected UE, etc. The storage unit 940 may store information that serves as a criterion for determining whether to provide or suspend multiple connections to the UE. In addition, the storage unit 940 may provide stored data in response to a request from the controller 950. The storage unit 940 may be configured as storage media such as ROM, RAM, hard disks, CD-ROMs, and DVDs, or a combination of the storage media. In addition, the storage unit 940 may be configured as a plurality of memories. The storage unit 940 may store a program to perform the above-described method for eDRX.

The controller 950 controls the overall operation of the primary BS. For example, the controller 950 may transmit and receive signals through the baseband processor 920 and the RF processor 910 or through the backhaul communication unit 930. In addition, the controller 950 may record and read data in and from the storage unit 940. To this end, the controller 950 may include at least one processor. In addition, The controller 950 may include a multi-connection processor 952 for performing a process for operation in a multi-connection mode.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to various embodiments of the disclosure.

The programs (software modules or software) may be stored in non-volatile memories including a random access memory and a flash memory, a ROM, an electrically erasable programmable read only memory (EEPROM), a magnetic disc storage device, a compact disc-ROM (CD-ROM), DVDs, or other type optical storage devices, or a magnetic cassette. Alternatively, any combination of some or all of them may form a memory in which the program is stored. A plurality of such memories may be included in the electronic device.

In addition, the programs may be stored in an attachable storage device which may access the electronic device through communication networks such as the Internet, Intranet, LAN, wide LAN (WLAN), and storage area network (SAN) or a combination thereof. Such a storage device may access the electronic device via an external port. A separate storage device on the communication network may access a portable electronic device.

It is understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

While the disclosure has been illustrated and described with reference to various embodiments of the present disclosure, those skilled in the art will understand that various changes can be made in form and detail without departing from the spirit and scope of the present disclosure as defined by the appended claims and their equivalents.

What is claimed is:

1. A user equipment (UE) in a wireless communication system, the UE comprising:
a transceiver; and
a controller coupled to the transceiver, and configured to:
identify, for a radio resource control (RRC) inactive state, a first extended discontinuous reception (eDRX) cycle associated with a core network (CN) entity and a second eDRX cycle associated with a radio access network (RAN) node, and
monitor a paging occasion in the RRC inactive state according to a DRX cycle,
wherein, in case that the first eDRX cycle is longer than 1024 radio frames and the second eDRX cycle is longer than 1024 radio frames:
during an overlapped period of a first paging time window associated with the CN entity and a second paging time window associated with the RAN node, the DRX cycle is determined by a shortest value among a first UE specific value configured by an upper layer, a second UE specific value configured by an RRC, and a default DRX value broadcasted in system information;
during a period included in the first paging time window associated with the CN entity and being outside of the second paging time window associated with the RAN node, the DRX cycle is determined by a shortest value among the first UE specific value configured by the upper layer and the default DRX value broadcasted in the system information; and
during a period included in the second paging time window associated with the RAN node and being outside of the first paging time window associated with the CN entity, the DRX cycle is determined by the second UE specific value configured by the RRC.

2. The UE of claim 1, wherein the controller is further configured to:
receive, from the RAN node, a system information block (SIB) including at least one of a first indicator, a second indicator, or a third indicator,
wherein the first indicator indicates that an eDRX for a CN paging is allowed in a cell,
wherein the second indicator indicates that an eDRX equal to or shorter than 10.24 second for RAN paging is allowed in the cell, and
wherein the third indicator indicates that an eDRX longer than 10.24 second for RAN paging is allowed in the cell.

3. The UE of claim 2,
wherein, in case that the first eDRX cycle is longer than 1024 radio frames, the first indicator is received, and the second indicator and the third indicator are not received:
during a period included in the first paging time window associated with the CN entity, the DRX cycle is determined by a shortest value among the first UE specific value configured by the upper layer, the second UE specific value configured by the RRC, and the default DRX value broadcasted in the system information; and
during a period being outside of the first paging time window associated with the CN entity, the DRX cycle is determined by the second UE specific value configured by the RRC.

4. The UE of claim 2,
wherein, in case that the first eDRX cycle is longer than 1024 radio frames, the first indicator and the second indicator are received, and the third indicator is not received:
during a period included in the first paging time window associated with the CN entity, the DRX cycle is determined by a shortest value among the first UE specific value configured by the upper layer, a value of the second eDRX cycle, and the default DRX value broadcasted in the system information; and
during a period being outside of the first paging time window associated with the CN entity, the DRX cycle is determined by the value of the second eDRX cycle.

5. The UE of claim 2,
wherein, in case that the first eDRX cycle is longer than 1024 radio frames and the second eDRX cycle is equal to or shorter than 1024 radio frames:
during a period included in the first paging time window associated with the CN entity, the DRX cycle is determined by a shortest value among the first UE specific value configured by the upper layer, a value of the second eDRX cycle, and the default DRX value broadcasted in the system information; and
during a period being outside of the first paging time window associated with the CN entity, the DRX cycle is determined by the value of the second eDRX cycle.

6. The UE of claim 1, wherein the controller is further comprising:
receive, from an access and mobility management function (AMF) entity, first information configuring the first eDRX cycle for an idle mode, and
wherein the first information includes information on the first paging time window.

7. The UE of claim 1, wherein the controller is further comprising:
receive, from a base station, second information configuring the second eDRX cycle for an inactive mode,
wherein the second information includes information on the second paging time window.

8. A method performed by a user equipment (UE) in a wireless communication system, the method comprising:
identifying, for a radio resource control (RRC) inactive state, a first extended discontinuous reception (eDRX) cycle associated with a core network (CN) entity and a second eDRX cycle associated with a radio access network (RAN) node; and
monitoring a paging occasion in the RRC inactive state according to a DRX cycle,
wherein, in case that the first eDRX cycle is longer than 1024 radio frames and the second eDRX cycle is longer than 1024 radio frames:
during an overlapped period of a first paging time window associated with the CN entity and a second paging time window associated with the RAN node, the DRX cycle is determined by a shortest value among a first UE specific value configured by an upper layer, a second UE specific value configured by an RRC, and a default DRX value broadcasted in system information;
during a period included in the first paging time window associated with the CN entity and being outside of the second paging time window associated with the RAN node, the DRX cycle is determined by a shortest value among the first UE specific value configured by the upper layer and the default DRX value broadcasted in the system information; and
during a period included in the second paging time window associated with the RAN node and being outside of the first paging time window associated with the CN entity, the DRX cycle is determined by the second UE specific value configured by the RRC.

9. The method of claim 8, further comprising:
receiving, from the RAN node, a system information block (SIB) including at least one of a first indicator, a second indicator, or a third indicator,
wherein the first indicator indicates that an eDRX for a CN paging is allowed in a cell,
wherein the second indicator indicates that an eDRX equal to or shorter than 10.24 second for RAN paging is allowed in the cell, and
wherein the third indicator indicates that an eDRX longer than 10.24 second for RAN paging is allowed in the cell.

10. The method of claim 9,
wherein, in case that the first eDRX cycle is longer than 1024 radio frames, the first indicator is received, and the second indicator and the third indicator are not received:
during a period included in the first paging time window associated with the CN entity, the DRX cycle is determined by a shortest value among the first UE specific value configured by the upper layer, the second UE specific value configured by the RRC, and the default DRX value broadcasted in the system information; and
during a period being outside of the first paging time window associated with the CN entity, the DRX cycle is determined by the second UE specific value configured by the RRC.

11. The method of claim 9,
wherein, in case that the first eDRX cycle is longer than 1024 radio frames, the first indicator and the second indicator are received, and the third indicator is not received:
during a period included in the first paging time window associated with the CN entity, the DRX cycle is determined by a shortest value among the first UE specific value configured by the upper layer, a value of the second eDRX cycle, and the default DRX value broadcasted in the system information; and
during a period being outside of the first paging time window associated with the CN entity, the DRX cycle is determined by the value of the second eDRX cycle.

12. The method of claim 9,
wherein, in case that the first eDRX cycle is longer than 1024 radio frames and the second eDRX cycle is equal to or shorter than 1024 radio frames:
during a period included in the first paging time window associated with the CN entity, the DRX cycle is determined by a shortest value among the first UE specific value configured by the upper layer, a value of the second eDRX cycle, and the default DRX value broadcasted in the system information; and
during a period being outside of the first paging time window associated with the CN entity, the DRX cycle is determined by the value of the second eDRX cycle.

13. The method of claim 8, further comprising:
receiving, from an access and mobility management function (AMF) entity, first information configuring the first eDRX cycle for an idle mode, and
wherein the first information includes information on the first paging time window.

14. The method of claim 13,
receiving, from a base station, second information configuring the second eDRX cycle for an inactive mode,
wherein the second information includes information on the second paging time window.
